(19) United States
(12) Patent Application Publication
(10) Pub. No.: US 2008/0073899 A1
(43) Pub. Date: Mar. 27, 2008

(54) Apparatus and method for binding thick sheets including photographs

(76) Inventors: Kevin P. Parker, Berkeley, CA (US); Wayne Kasom, Oakland, CA (US); Harold P. Hocking, Manhattan Beach, CA (US); Nicholas G. Paget, San Francisco, CA (US)

Correspondence Address: Philip A. Girard;GIRARD & EQUITZ LLP, Suite 1110, 400 Montgomery Street, San Francisco, CA, 94104, US

(21) Appl. No.: 11/591,186

(22) Filed: Nov. 1, 2006

Related U.S. Application Data
(63) Continuation-in-part of application No. 11/528,716, filed on Sep. 27, 2006.

(51) Int. Cl. B42D 1/00

(52) U.S. Cl. 281/21.1

(57) ABSTRACT

A carrier assembly for use in binding a plurality of display sheets such as photographs and including a first and second carrier sheet arrangements, with each arrangement including a pair of carrier sheets separated by a fold, with the carrier sheets each having generally the same dimensions as the display sheets to be bound. The interior surfaces of the four sheets are covered by a layer of pressure sensitive adhesive, with each layer of adhesive being covered by a release liner and with an exterior surface of the two carrier sheet arrangements being secured together form a basic unitary structure that can be expanded upon. Four display sheets to be bound can then be positioned within the arrangements and over the respective release liners so that the liners can then be successively removed for accurate display sheet positioning.

### CROSS REFERENCE TO RELATED APPLICATIONS

The present application is a continuation-in-part application of application Ser. No. 11/528,716 filed on Sep. 27, 2006.

### BACKGROUND OF THE INVENTION

1. Field of the Invention

The present invention relates generally to binding apparatus and, in particular, to binding apparatus and methods for binding thick sheets such as photographs.

2. Related Art

Photograph albums are becoming more popular, particularly with the advent of digital photography. One conventional approach is to secure the individual photographs in a pre-bound album having individual sheets to which the photographs are attached using adhesives and the like. The advantage of this approach is reduced costs at the expense of appearance. It is also possible to produce a photo album using commercial binding techniques to provide a more attractive product, but at a very substantial cost.

A typical commercially bound photo album, without the hardcover, is depicted in FIGS. 1A-1C of the drawings. An exemplary photograph 20 to be bound is shown in FIG. 1A for producing the bound album. The photograph 20 includes a central score line 22 to facilitate folding the photograph. Thus, for an album that is approximately 4×5 inches, the photograph 20 should be 8×5 inches. Multiple images can be placed on the photograph using photo editing techniques, taking into account that the photograph will be folded in the center. Images are printed only on one side of the photograph 20. The album shown in FIGS. 1B and 1C includes a total of three folded photographs 20A, 20B and 20C to provide a total of four album pages. One half of photograph 20A forms one page, with the other half of photograph 20A and half of photograph 20B forming a second page. The remaining third and fourth pages of the album are formed from the second half of photograph 20B and photograph 20C. The photographs 20A, 20B and 20C are each folded so that the images of each photograph face one another. The three photographs are secured to one another by way of two layers of adhesive 26 which attach the non-image side of the photographs together.

The three photographs are bound together, as represented by symbol 24, using conventional commercial binding techniques. Typically, the pages are bound together using an adhesive, with a reinforcing cloth present to add strength. These techniques are suitable for accommodating photographs which, as compared to sheets of paper, are relatively thick and rigid, particularly at the regions where the photographs are adhered together. The final album, with added hardcover, is attractive but very expensive and is thus usually reserved for wedding albums and albums for other special occasions.

Another conventional binding approach is illustrated schematically in FIG. 2 where four individual photographs 28A, 28B, 28C and 28D are bound together using a conventional binder strip applied using a conventional desk-top binding machine. As explained in detail in U.S. Pat. No. 5,052,873, a stack of sheets of paper can be bound using a binder strip that includes a layer of heat activated adhesive. The stack is inserted into the binding machine, with the machine functioning to apply the binder strip to the stack edge and to apply heat so as to activate the adhesive. Once the adhesive has cooled, a hardcover can then be applied to the bound stack. The same approach can be used to bind photographs, with numeral 30 representing the binder strip adhesive. This approach provides an attractive photo album at a very low price compared to the previously described commercial binding techniques. However, since each page includes only one photograph having an image on one side only, the back of each photograph can be observed by a viewer. This is a disadvantage in some applications, particularly when photo paper information or the like is printed on the backside of the photo. It would be possible to glue the back of two photographs together to provide one album page for each of the two photographs. However, because each page includes two photographs, the pages would be relatively thick and rigid. Such pages are not ideal for binding using the binder strip.

Epson American Inc. markets a product under the name “Story Teller Photo Book Creator” which is schematically depicted in FIG. 3. The product includes a bound stack of plain sheets which are bound together using conventional binding techniques represented by adhesive 30. Only a single complete bound plain sheet is depicted, with that bound sheet including a binding section 38A and a detachable section 40 separated from the binding section by perforations 42. The remaining bound sheets include bound sections 44B, 44C and 44D, with the associated detachable sections being previously removed by the end user. The plain sheet formed by binding section 38A and detachable sheet 40 has the same approximate dimensions as the photographs so that, among other things, the plain sheets 38/40 can be used to align the photographs with respect to the associated binding sections. Also depicted are fly leaves 34A and 34B which are also bound together with the sheets. The bound combination is provided with a hardcover which includes front and back cover sections 36A and 36B connected together by an intermediate spine section 36C. Each binding section 38A, 38B, 38C and 38D has an associated strip of pressure sensitive adhesive, including respective adhesive strips 44A, 44B, 44C and 44D. Each strip of pressure sensitive adhesive was originally covered by a release liner, with the liners having been previously removed during the assembly process.

The end user secures an individual photograph to each of the bound sheets by first positioning the photograph, photograph 46A for example, over one of the complete bound sheets which would include, for example, binding section 38A and attached detachable section 40. Once the photograph is aligned, the associated release liner is removed, with the user maintaining the photograph in proper alignment, thereby exposing the underlying pressure sensitive adhesive, such as adhesive 44A. The user then presses the photograph, such as photograph 46A, against the adhesive thereby securing the photograph to the binding section 38A. The user can then, if desired, remove the associated detachable sections, such as section 40. A significant disadvantage of this approach is that, as is the case of the FIG. 2 prior art embodiment, the back sides of the photographs are exposed to the viewer.

A still further prior art approach is shown in FIGS. 4A, 4B, 4C and 4D. This approach is marketed by ZoomAlbum, LLC under the name ZoomAlbum. As described at www.ZoomAlbum.com the user purchases photographic album paper which includes several individual sheets arranged in a single larger sheet. The larger sheet of photographic paper also includes various layers of pressure sensitive adhesive (not depicted in FIGS. 4A and 4B) which are presumably covered by separate release liners. Using software provided by the manufacturer, the user inserts the larger sheet of photographic paper in an ink jet printer, with the software allowing the user to locate individual images on the individual sheets of the larger sheet. Once the images are printed, the user reconfigures the large sheet, presumably using suitably located perforations and/or score lines, to arrive at a final assembly 48 as depicted in FIGS. 4A and 4B. The exemplary assembly 48 includes individual images 54A-54L applied by the printer. The images are separated by what appears to be folding cuts 50A-50E which permit the assembly to be folded at the cuts so as to provide a clean outer edge for each page of the album. The images are also separated by scribe lines or the like 52A-52F which also permit the assembly to be folded, with the scribe lines 52A-52F functioning as hinges when a user views the individual pages.

As previously noted, the assembly 48 includes various layers of pressure sensitive adhesive presumably covered with some form of release liner so that the adhesive can be exposed when required. As can be seen in FIG. 4C, pressure sensitive adhesive layers 56A-56L function to secure the back side of the image sheets together, with FIG. 4C illustrating the adhesive layers before they are forced together. By way of example, layers 56B and 56C secure the rear of the sheets carrying images 54B and 54C together so that the two image sheets form a single album page, with an image on both sides. When the ten image sheets are secured together in this manner, a total of five album pages 54B/C, 54D/E, 54F/G, 54H/I and 54J/K are produced as indicated schematically in FIG. 4D for the depicted exemplary embodiment in an open position. As also shown schematically in FIG. 4D, the folded edges 52A-52F come together to form a relatively continuous spine edge 58 which extends between front and rear cover sections 36A and 36B.

One shortcoming of the prior art approach of FIGS. 4A-4D is that specialized photographic paper having precut sections and pressure sensitive adhesives must be used. Further, it appears that size of the individual photographic images is limited since all of the images for a single book have to be printed on a single sheet.

There is a need for a relatively low cost approach for binding photographs and the like using desk-top equipment that produces an attractive bound volume having an appearance that approaches that of a commercially bound album. Such an approach would preferably not require the use of special photo-paper. As will become apparent from one skilled in the art upon a reading of the following Detailed Description of the Invention together with the drawings, the disclosed invention addresses the above-noted shortcomings of the prior art in addition to providing further advantages.

### SUMMARY OF THE INVENTION

A bound book especially adapted for displaying photographs and the like is disclosed along with other embodiments and methods. The book includes first and second display sheets, such as photographs, which are positioned within a carrier sheet arrangement. The carrier sheet arrangement is folded at least once to provide first and second carrier sheets separated by a fold, with each of the carrier sheets having dimensions similar to that of the first and second display sheets. A first fastening layer is provided which is disposed intermediate the first carrier sheet and the first display sheet, with the first fastening layer securing the first display sheet to the first carrier sheet. Similarly, a second fastening layer is provided disposed intermediate the second carrier sheet and the second display sheet, with the second fastening layer securing the second display sheet to the second carrier sheet. Both the first and second display sheets are secured so that a first edge of each sheet is disposed adjacent the first fold.

The book further includes a cover assembly including first and second covers, with the first and second display sheets being disposed intermediate the first and second covers, with the display sheets further being positioned such that the display sheets contact each other when the book is closed.

In one embodiment of the present invention, the first and second fastening layers include heat activated adhesive. The fastening layers are thus activated by applying heat to the photographs and carrier sheet arrangement combination. Moderate pressure is also applied to insure a secure bond. In a further embodiment, the first and second fastening layers on the carrier sheet arrangement include pressure sensitive adhesive and an associated support structure to prevent the pressure sensitive adhesive from adhering during assembly of the book when the display sheets are initially positioned over the fastening layers. Once the display sheets have been positioned on the carrier sheet arrangement, a substantial compression force is applied, preferably using a desk-top press, so as to displace the support structure of each fastening layer so that the adhesive in the fastening layer is available to secure the display sheet. Once the display sheets have been secured, or during such securing, the carrier sheet arrangement is installed in a hardcover assembly.

### BRIEF DESCRIPTION OF THE DRAWINGS

FIG. 1A is a prior art photograph adapted to be bound in an album.

FIG. 1B is an end view of a prior art album using the photographs of FIG. 1A.

FIG. 1C is a perspective view of the prior art album of FIG. 1B.

FIG. 2 is a perspective view of another prior art approach to binding photographs, showing only the bound spine region.

FIG. 3 is a still further prior art approach to binding photographs where a pre-bound book is provided to which photographs are added.

FIGS. 4A and 4B show a prior art assembly of photograph paper in a fanfold arrangement.

FIG. 4C shows a prior art bound photograph album utilizing the fanfold arrangement of FIGS. 4A and 4B.

FIG. 4D is a schematic view of showing the bound spine edge of the prior art album of FIG. 4C.

FIG. 5A is a top view of a carrier assembly in accordance with one embodiment of the present invention showing the assembly prior to folding.

FIG. 5B is a side view of the carrier assembly of FIG. 5A after folding.

FIG. 6A is a side view of a carrier assembly in accordance with one embodiment of the present invention showing photographs positioned on a carrier assembly similar to that of FIGS. 5A and 5B prior to activation of the fastening layers that secure, among other things, the photographs to the carrier assembly.

FIG. 6B is a schematic view of the loaded carrier assembly of FIG. 6A and FIG. 6C is an enlarged partial view of FIG. 6B showing details of the loaded carrier assembly in a slightly compressed position showing the relative locations of the carrier sheets, fastening layers and photographs.

FIG. 7 is a perspective view of a user positioning photographs in a carrier assembly similar to that shown in FIGS. 5A and 5B.

FIG. 8A shows a loaded carrier assembly of FIGS. 6A, 6B and 6C utilizing pressure sensitive adhesive based fastening layers positioned on the bottom plate of a press prior to compression.

FIG. 8B shows the loaded carrier assembly of FIG. 8A during compression by the press, with such compression functioning to activate the fastening layers.

FIG. 9 is a schematic end view showing details of the spine region of an album bound in accordance with one embodiment of the present invention, with the album being disposed in a hardcover assembly.

FIGS. 10A, 10B and 10C show one embodiment of a pressure sensitive adhesive based fastening layer.

FIGS. 11A, 11B and 11C show another embodiment of a pressure sensitive adhesive based fastening layer.

FIGS. 12A, 12B and 12C show a further embodiment of a pressure sensitive adhesive based fastening layer.

FIGS. 13A, 13B, 13C and 13D show a still further embodiment of a pressure sensitive adhesive based fastening layer.

FIGS. 14A, 14B and 14C show another embodiment of a pressure sensitive adhesive based fastening layer.

FIGS. 15A, 15B and 15C show an additional embodiment of a pressure sensitive adhesive based fastening layer.

FIG. 16 is a graph depicted the relationship between adhesion strength and applied force for an exemplary pressure sensitive adhesive fastening layer of the present invention and a corresponding relationship for a conventional pressure sensitive adhesive.

FIG. 17A shows a loaded carrier assembly utilizing a heat activated fastening layer in accordance with one embodiment of the present invention, with the loaded carrier positioned on the bottom plate of a heated press prior to activation.

FIG. 17B shows the loaded carrier assembly of FIG. 17A being activated by the heated press as the press applies heat to the assembly along with pressure.

FIG. 18 is a side partial view of a loaded carrier assembly as in FIG. 17A, with the bottom plate of the heated press including sidewalls for supporting the carrier assembly and with a thin electrical heating element disposed in the center of the assembly to provide supplemental heat to the assembly.

FIG. 19A is a perspective view of the lower press base showing a loaded carrier positioned on the base of the heated press with a contact of the thin heating element extending through a cut-out formed in a sidewall of the base, with FIGS. 19B and 19C schematically illustrating the tilt angle of the lower press base relative to a level plane.

FIG. 20 is another embodiment photo-album showing the carrier assembly secured to a hardcover assembly using pressure sensitive adhesive located on the assembly.

FIG. 21 is a hardcover assembly which utilizes a pair of pressure sensitive adhesive based fastening layers for securing the hardcover assembly to the carrier assembly at the same time the carrier assembly and photographs are bound.

FIG. 22 is another embodiment photo-album showing the carrier assembly secured to a hardcover assembly using pressure sensitive adhesive located on the assembly, with the front cover section including a window for viewing a portion of a photograph mounted on the inner surface of the front cover section.

FIGS. 23A, 23B, 23C and 23D shows a pair of pressure activated based fastening layer incorporating fibers such as flock, with the fibers arranged on opposing fastening layers to reduce adhesion between the fastening layers.

FIGS. 24A, 24B and 24C show on embodiment of a two carrier sheet carrier arrangement having four fastening layers.

FIGS. 25A, 25B and 25C show on embodiment of a two carrier sheet carrier sheet arrangement having three fastening layers.

FIGS. 26A, 26B and 26C show on embodiment of a two carrier sheet carrier sheet arrangement also having three fastening layers, with one the layer location differing from that of FIGS. 25A, 25B and 25C.

FIGS. 27A, 27B and 27C show on embodiment of a two carrier sheet carrier sheet arrangement having two fastening layers.

FIGS. 28A, 28B and 28C show on embodiment of a two carrier sheet carrier sheet arrangement having one fastening layer.

FIGS. 29A, 29B and 29C show the various embodiments of a two carrier sheet carrier sheet arrangement with photographs positioned on the inner fastening layers.

FIG. 30 is an photograph album formed from the various two carrier sheet carrier sheet arrangements of FIGS. 29A, 29B, 29C, 29D and 29E illustrating an exemplary application for the carrier sheet arrangements.

FIG. 31A is a further arrangement for supporting photographs for a photo-album.

FIG. 31B is an alternative embodiment two-sided fastening layer for use in the FIG. 31A arrangement.

FIG. 32 is a schematic diagram of a hardcover photo-album utilizing the alternative arrangement of FIG. 31A.

FIG. 33 is a plan view a still further embodiment of a carrier sheet arrangement utilizing pressure sensitive adhesive.

FIG. 34 is an end view of the carrier sheet arrangement of FIG. 33.

FIG. 35 is an alternative embodiment carrier assembly which a combination of four of the carrier sheet arrangements of FIGS. 33 and 34.

FIG. 36 is an enlarged portion of the dog ear tab of one of the release liners of the FIG. 35 carrier assembly.

FIG. 37 is a schematic diagram of the carrier assembly of FIG. 35 with mounted photographs and end leaves.

FIG. 38 is a perspective view of an alternative embodiment caddy for use in assembling the loaded carrier assembly of FIG. 37

FIGS. 39A, 39B and 39C show part of the sequence of assembling the loaded carrier assembly of FIG. 37.

FIGS. 40A and 40B illustrate some the steps for securing a photograph in the carrier assembly of FIG. 35.

FIG. 41 is a plan view of a further embodiment of a carrier sheet arrangement using pressure sensitive adhesive.

FIG. 42 is a perspective view of a registration guide for aligning photographs on the carrier sheet arrangement of FIG. 41.

FIG. 43 is a perspective view of a carrier assembly which includes several of the carrier sheet arrangements of FIG. 41 and the registration guide.

FIG. 44 is a plan view of the carrier assembly and registration guide of FIG. 43.

FIG. 45 is a schematic elevational side view of the carrier assembly and registration guide of FIG. 44 resting on a surface, with the various individual carrier sheet arrangements which make up the carrier assembly being depicted.

FIGS. 46A and 46B show part of the sequence for mounting photographs on the carrier assembly of FIG. 43.

FIG. 47 is a perspective view of a prefabricated hardcover and an attached carrier assembly similar to that of FIGS. 43 and 44 to be used in creating a photo-album.

FIG. 48 is a side view of the prefabricated hardcover and carrier assembly of FIG. 47 with two photographs installed.

FIGS. 49A-49D show a sequence for securing a cover photograph in the FIG. 47 hardcover and carrier assembly so that the cover photograph can be viewed through window in the hardcover.

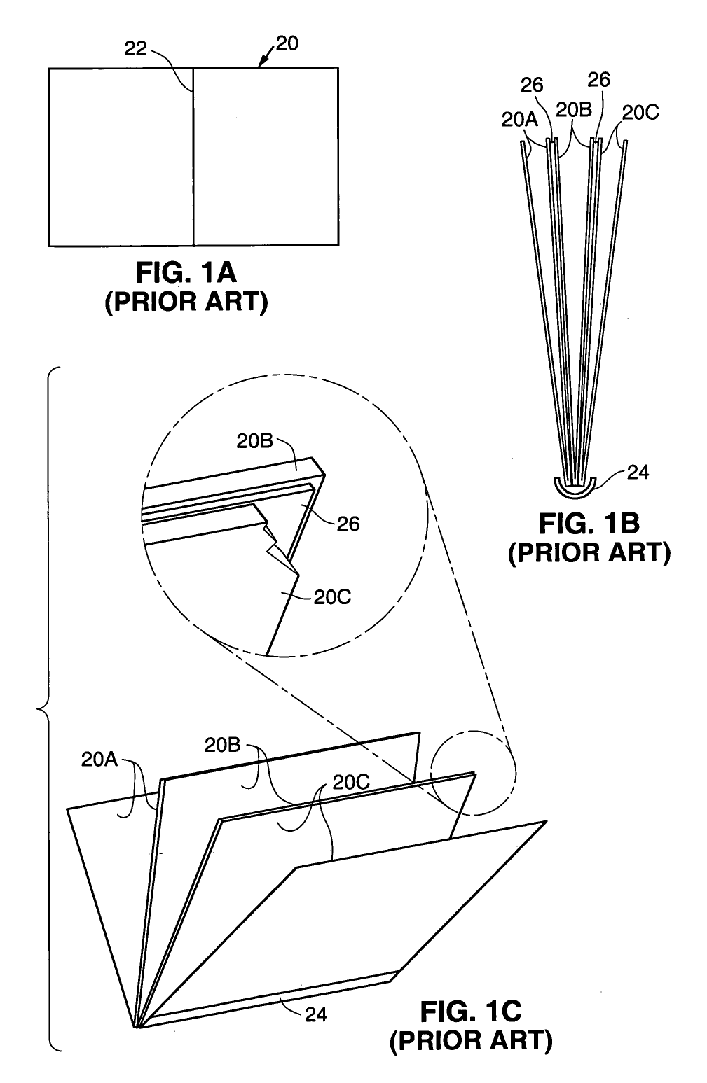

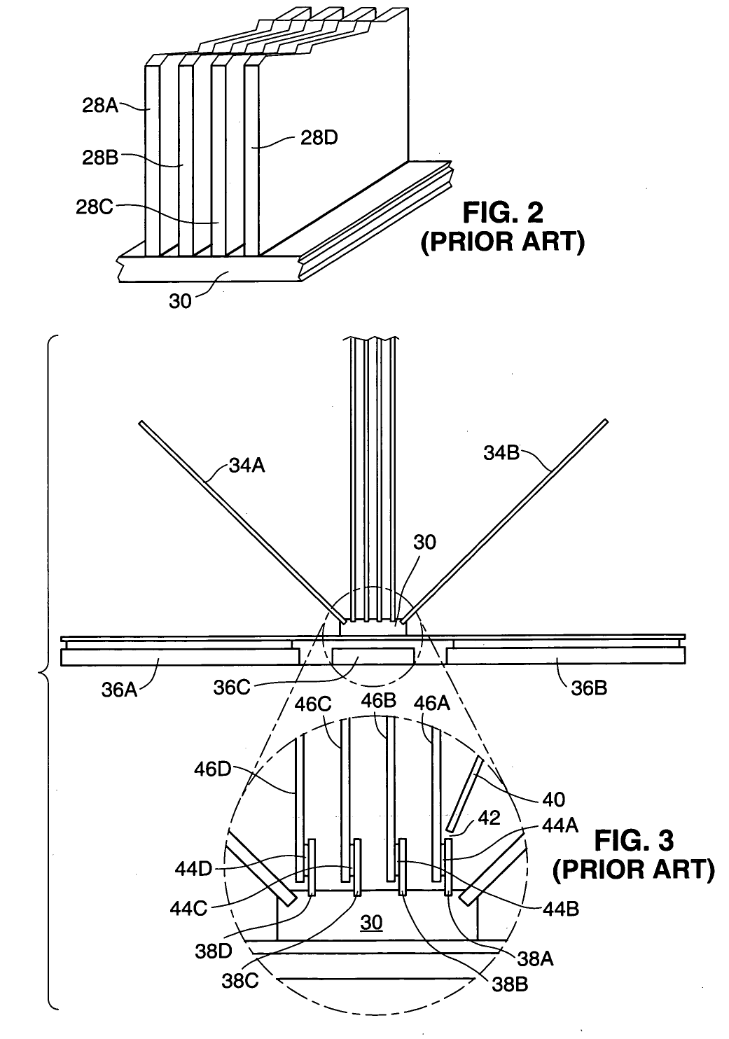

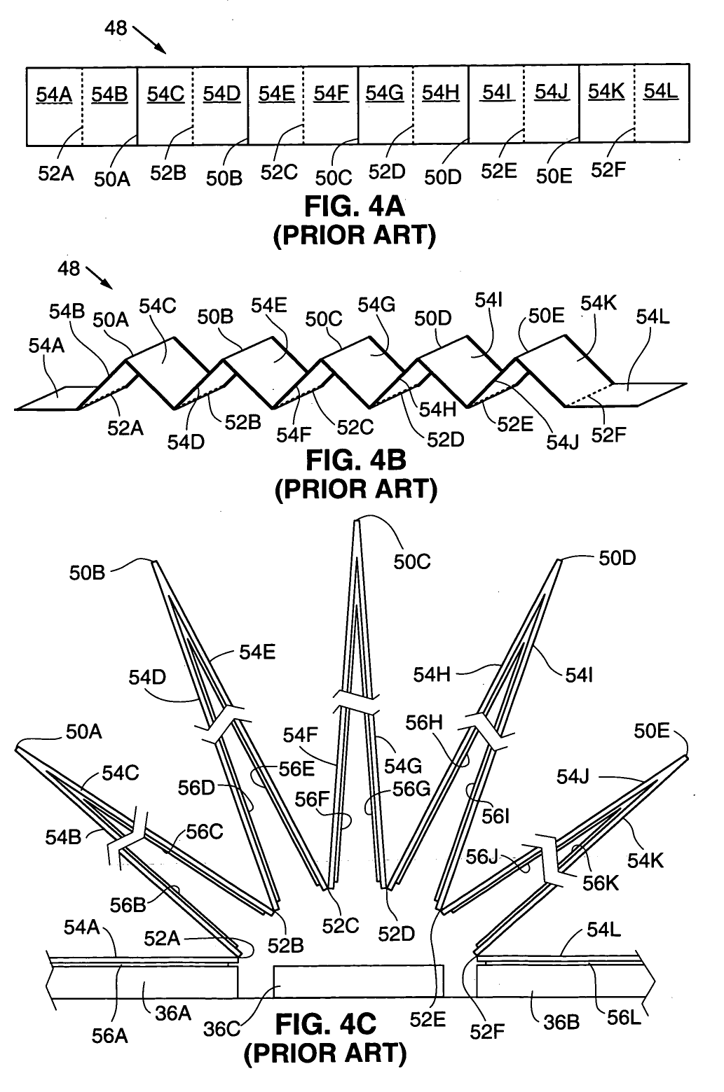

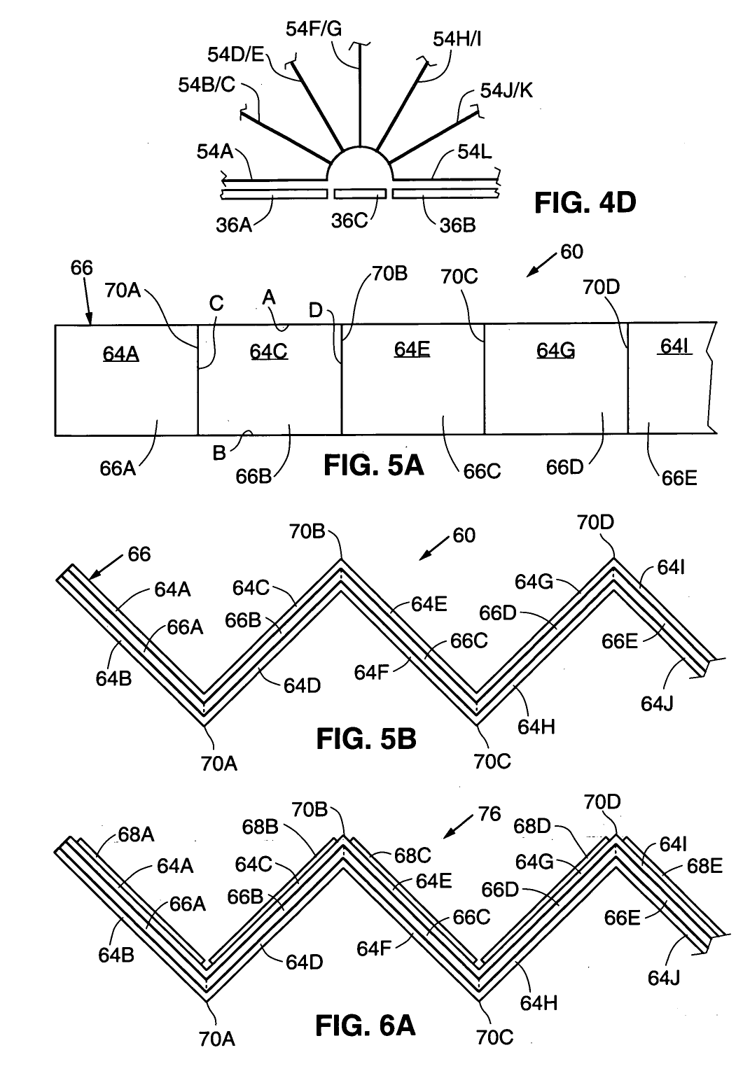

### DETAILED DESCRIPTION OF THE INVENTION

Referring again to the drawings, FIGS. 5A and 5B illustrates one embodiment of a carrier sheet arrangement 60, sometimes referred to as a carrier assembly, for forming a bound photo-album. It is to be understood that the present invention has applications other than binding photographs, including the binding of sheets that are relatively rigid and thick as compared to sheets of paper. The carrier sheet arrangement 60 is formed from a relatively heavy paper such as 80 pound weight Kraft paper which has strength and which can be readily folded to form and hold a sharp fold. The carrier sheet arrangement 60 includes generally one individual carrier sheet 66 (sheets 66A-66E) for each photograph to be bound. In some applications, the end carrier sheets 66A and 66E do not support a photograph but are used exclusively for securing the carrier sheet arrangement 60 or an end leave to a hardcover assembly. Both sides of each of the carrier sheets 66A-66E are covered by a fastening layer 64, some of which are used to secure the photographs to the carrier sheets and some of which are used to secure the carrier sheets together. In one embodiment, the fastening layers include heat activated adhesive and in another embodiment, the fastening layers include pressure activated adhesive. The pressure activated adhesive embodiment will be described first.

Each of the carrier sheets 66A-66E has dimensions close to that of the photographs to be bound. As can best be seen in FIG. 5B, the carrier sheets are preferably formed from a single piece of elongated material of Kraft paper, with the individual sheets being created by folding the elongated material at appropriate locations 70A, 70B, 70C and 70D so as to provide a fan-folded arrangement. The pressure-activated fastening layers 64 may then applied to the surfaces of the carrier sheets. As will be described in greater detail, the fastening layers 64 have a low tackiness when only small amounts of pressure are applied such as typically occur when handling the carrier sheet arrangement 60 during shipping and when initially positioning the photographs on the carrier sheets. When a relatively large amount of pressure is applied, the fastening layers become permanently highly aggressive so as to provide strong permanent adhesive bonds. Although the edges of the fastening layers 64 are shown in FIGS. 5A and 5B extending all of the way to the edges of the carrier sheets 66 on which the fastening layers are mounted, it is preferred that the fastening layers not extend all of the way to the carrier sheet edges. By way of example, the fastening layer 64C of FIG. 5A is shown having edges A, B, C and D, with those edges being depicted generally coincident with the edges of the carrier sheet 66B. However, edges C and D are each also preferably offset from the edges of the carrier 66B sheet defined by respective folds 70A and 70B by about 3/16 of an inch. Edges A and B are each preferably offset from the respective edges of the carrier sheet 66B by about 3/32 of an inch. It has been found that these offsets result in more attractive edges for the individual pages of the final product.

The carrier assembly 60 is preferably pre-manufactured and provided to an end user or assembler who assembles the photo-album for the ultimate customer. The customer typically provides the photographs for the album to the assembler. The carrier assembly 60 typically includes a large number of individual carrier sheets 66, with the assembly being cut along an appropriate one of the fold lines 70 so that the number of carrier sheets corresponds to the number of photographs to be bound. Alternatively, perforations could be added along the fold lines to that the carrier assembly sheets can be separated without cutting. As previously noted, the carrier sheets 66 are covered on both sides by a fastening layer 64. The fastening layer 64 can be implemented using either heat activated or pressure activated adhesive. The present embodiment utilizes fastening layers which incorporate pressure sensitive adhesive. As will be described in greater detail, the fastening layers are implemented to provide minimal adhesion during shipping and during the early stages of the assembly process without the use of release liners.

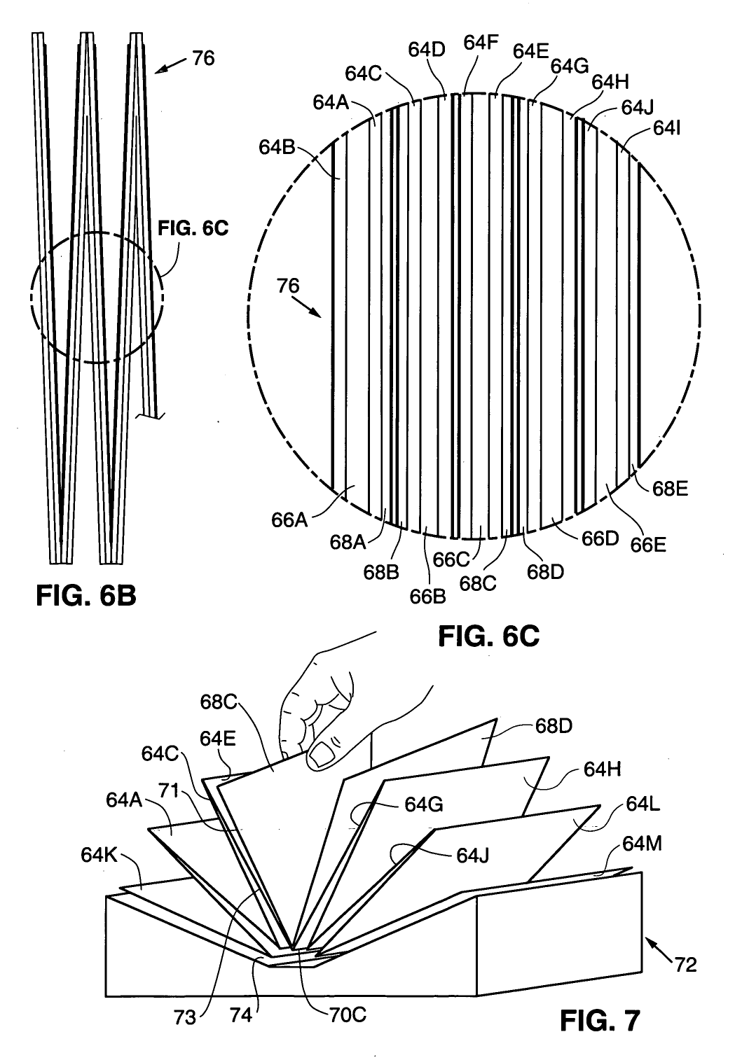

Once the proper number of carrier sheets 66 for the carrier assembly 60 has been selected, the assembler positions the photographs 68 on the carrier assembly 60 as shown in FIGS. 6A and 7. In doing so, the photographs are positioned over the carrier sheets 66, with one of the fastening layers 64 being disposed between the photograph and the carrier sheet. The end sheets of the carrier assembly 60, such as sheet 66A, function to secure the carrier assembly to either a front or rear cover of a hardcover assembly as will be described. The end sheets may or may not also support a photograph depending on the customer's choice. One advantage of the subject carrier assembly 60 is that it is easy for the assembler to accurately position the photographs, an important requirement for an attractive final product. Ease of assembly is further greatly enhanced by the fact that the fastening layers, at this stage of the assembly, provide negligible adhesion and thus do not interfere with proper positioning of the photographs.

FIG. 7 shows a caddy 72 which is preferably used for loading the photographs 68 on the carrier assembly 60. The unloaded assembly 60 is first positioned on a receiving surface 74 of the caddy 72, with the surface being shaped to hold the assembly in an almost, but not complete, open position. This is sometimes called the expanded position for the carrier assembly 60. The receiving surface 74 is also angled so that the lower portion of the carrier assembly 60, which is located near the assembly person, is lower that the upper portion of the assembly. A lower stop, not depicted in FIG. 7 supports the lower edge of the carrier assembly 60 so that the assembly does not slide off the caddy. Thus, when photographs 68 are positioned over the carrier sheets as shown in FIG. 7, the photographs tend to drop down towards the intermediate folds in the carrier assembly and remain in that position. By way of example, photographs 68C and 68D, when placed over respective fastening layers 64E and 64G of respective sheets 66C and 66D, will drop down due to gravity, with the lower edges of photographs 68C and 68B both being positioned adjacent the corresponding fold 70C of the carrier assembly.

In addition, the photographs 68 will tend to slide down to the lower stop in the caddy 72 due to gravity so that the lower edges of the photographs are aligned with the lower edges of the associated carrier sheet. This will ensure that the upper edges of the photographs, edge 71 of FIG. 7 for example, will also be aligned with the upper edges of the associated carrier sheet, edge 73 for example, since the dimensions of the carrier sheets and the photographs are the same in this direction. The dimensions of the carrier sheets are also such that when the photograph edges are positioned adjacent the associated fold, such as photographs 68B and 68C of FIG. 6A, the outer edges of the photographs do not quite reach the common fold line, such as fold line 70B. After assembly is completed and compressed, as will be described, a small section of the outer edges of each photograph together with the underlying carrier sheets near the fold lines are trimmed to provide an attractive and even exposed edge for each page of the album. Once the initial photographs have been positioned in the carrier assembly 60, gravity tends to hold the photographs in place so that the remaining photographs can be easily positioned without disturbing these previously positioned photographs.

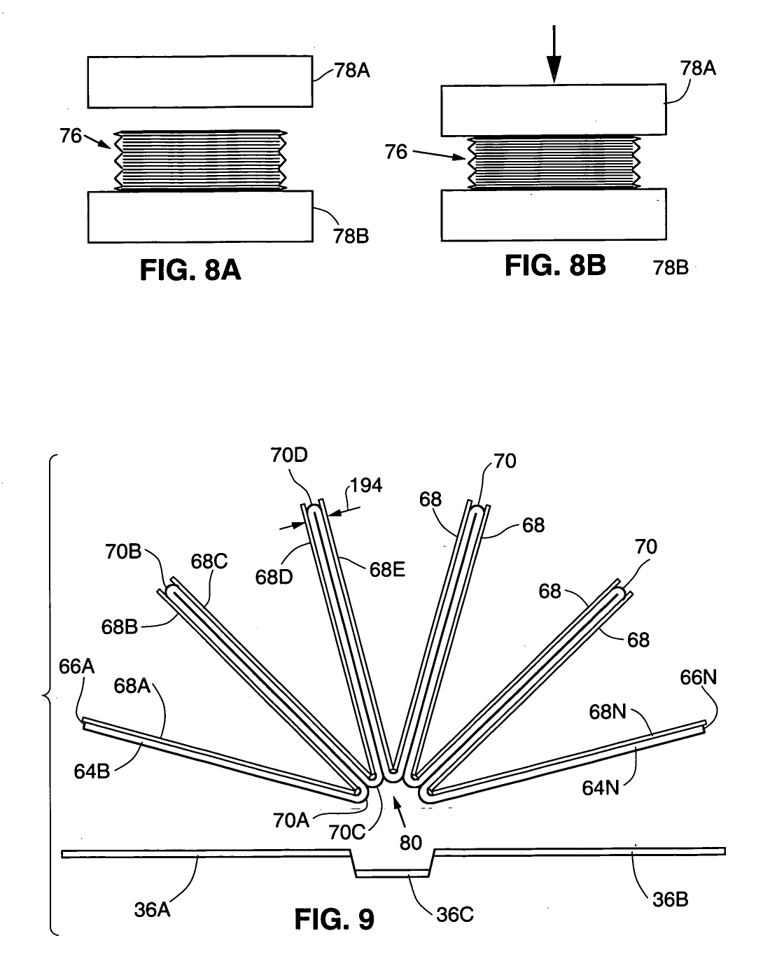

Once all of the photographs 68 have been positioned in the carrier assembly 60, the loaded assembly 76 is carefully moved from an expanded state of FIG. 7 to a compressed state as shown schematically in FIGS. 6B and 6C by manually applying a slight compression force. This force maintains the correct position of the photographs on the carrier assembly. The loaded and compressed carrier assembly 76 is then positioned between the front and back covers of a hardcover assembly so that, for example, fastening layer 64B is positioned adjacent the inside of the front cover and so that another fastening layer is positioned adjacent the inside of the rear cover. The loaded carrier assembly 76 and hardcover assembly are then transferred to a desk-top press as depicted in FIG. 8A. The press includes upper and lower plates 78A and 78B which function to apply a compression force of typically 50 to 100 pounds per square inch of carrier assembly area, with the actual force depending upon the characteristics of the fastening layers 64. As will be explained, this force will activate each of the fastening layers 64 so that the pressure sensitive adhesive in the layers will permanently secure selected components of the loaded carrier assembly together. After compression, the press is opened so that the loaded carrier assembly and hardcover can be removed.

As can be seen schematically in FIG. 6C, compression causes the various fastening layers 64 to secure selected elements of the loaded carrier assembly 76 together, with FIG. 6C showing some of the selected elements in a compressed form, a form where the photo-album is closed. FIG. 9 shows the complete photo-album, including additional pages not depicted in FIG. 6C, in an open form, including the hard cover assembly which includes respective front and back covers 36A and 36B and intermediate spine section 36C. As can best be seen in FIG. 6C, the activated fastening layer 64B functions to secure carrier sheet 66A to the front cover 36A of FIG. 9. Another fastening layer 64, not shown in FIG. 6C, is located on the opposite side of the carrier assembly and functions to secure a carrier sheet assembly to the back cover 36B. Thus, the hardcover assembly is secured to the carrier assembly at the front and back cover sections and not to the spine section 36C so that the album will tend to lay flat when fully opened as shown in FIG. 9.

Continuing, after compression fastening layer 64A will become activated and will function to secure photograph 68A to the carrier sheet 66A. Thus, the inner side of the front cover 36A will display photograph 68A. In addition, fastening layer 64C will secure photograph 68B to carrier sheet 66B and fastening layer 64E will secure photograph 68C to carrier sheet 66C. Continuing, fastening layers 64D and 64F will function together to secure the backsides of carrier sheets 66B and 66C together so that photographs 68B and 68C, together with intermediate carrier sheets 66B and 66C, form a single page of the album. That page includes photograph 68B on one side and photograph 68C on the opposite side. Similarly, photographs 68D and 68E, together with intermediate carrier sheets 66D and 66E, form a further page of the album. The album would typically include other carrier sheets of the carrier arrangement 60 along with associated photographs so that the album would include additional pages as shown in FIG. 9.

As can also be seen in FIG. 9 and as previously noted, the fastening layers 64 function to secure front and back carrier sheets to the inner surface of the respective front and back cover sections 36A and 36B. Further, the fastening layers 64 function to secure selected adjacent carrier sheets together to form a flexible spine 80. By way of example, fastening layers 64D and 64F secure the entire respective surfaces of carrier sheets 66B and 66C together so that the fold lines 70A and 70C are disposed adjacent one another to form a single page. The single pages are all secured together at the spine 80 by the carrier assembly itself. Note that it would be possible to pre-manufacture the carrier assembly 60 so that the carrier sections that become secured together along the full surface, such as carrier sections 66B and 66C, are glued together using conventional book binding adhesives or the like. In that event, certain fastening layers, such as layers 64D and 64F, can be deleted from the carrier assembly 60 provided to the assembler. As previously noted, it is preferably that the outer edges of the pages that make up the album be trimmed. As indicated by arrow 194 of FIG. 9, the page is trimmed so as to remove part of the photographs 68D and 68E and part of the underlying folded carrier sheets which form fold 70D so that the material forming the fold is removed. This cut is preferably not so deep as to expose the underlying pressure sensitive adhesive which, as previously described, terminates about 3/16 of an inch from the fold 70D. This presents an attractive even edge free of adhesive, so that the edge does not attract debris and the like which could possibly adhere to any exposed adhesive. As also previously noted, the adhesive of the fastening layer is displaced typically 3/32 of an inch from the edges that form the top and bottom of the album pages thereby further proving an attractive edge free of any collected debris.

Details regarding the construction of the fastening layers 64 will now be provided. As previously noted, an objective of the fastening layers 64 is to provide negligible adhesion when the layer is subjected to low forces such as are present when the carrier assembly 60 is shipped and when photographs 68 are being positioned on the carrier assembly. Any significant adhesion would, for example, greatly complicate accurate positioning of the photographs.

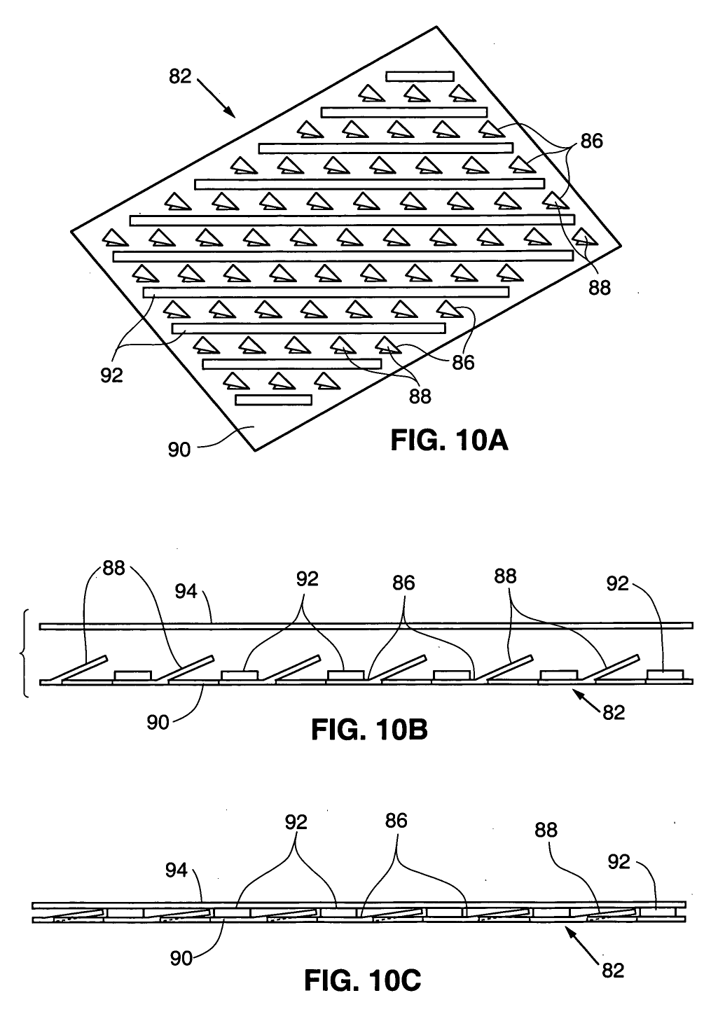

FIGS. 10A, 10B and 10C illustrate one embodiment of the subject fastening layers, sometimes referred to as the flap style fastening layer 82. As is the case for many of the fastening layer embodiments, fastening layer 82 utilizes part of the underlying carrier sheet designated sheet 90. As can best be seen in FIG. 10A, fastening layer 82 includes an array of generally triangular shaped flap members 88 (not all are designated) cut into the carrier sheet 90. The flap members 88 remain secured to the carrier sheet by way of hinge sections 86 (not all designated) so that the flap members can move between a folded upright position as shown in FIGS. 10A and 10B and a flattened position as shown in FIG. 10C. A small but finite force is required to displace each of the flap members 88 from the upright to a more flattened position. The flap members 88, which are sometimes referred to collectively as the support structure, are arranged in an array, with there typically being at least one flap member per square inch of fastening layer 82 area and preferably approximately 25 members per square inch.

Fastening layer 82 further includes a layer of pressure sensitive adhesive such as a hot melt pressure sensitive adhesive sold by HB Fuller under the designation HM-2713. Unless noted otherwise, a thickness of the pressure sensitive adhesive layer for the various embodiment fastening layers ranging from 1 to 1½ mils has been found to be satisfactory, with this thickness being adjustable to alter the characteristics of the fastening layer as needed. The adhesive layer includes several individual adhesive strips 92 disposed on the surface of the carrier sheet intermediate the array of flap members 88. When the carrier sheet is manufactured, the flap members 88 are positioned (folded) to extend away from the carrier sheet in an upright position and to extend through and past the upper surface of the adhesive layer comprised of adhesive segments 92. Thus, if some generic compressing sheet 94, such as a photograph or the like, is resting on the fastening layer 82, the support structure formed by the various upright flap members 88 will prevent the compressing sheet 94 from contacting the upper surface of the adhesive layer as defined by adhesive segments 92. Thus, the compressing sheet 94 does not adhere to the fastening layer or the underlying carrier sheet. However, if a large compression force were applied to the fastening layer 82 by way of a compressing sheet 94, the force would be sufficient to displace the support structure, that is, sufficient to force the flap members 88 down below the upper surface of the adhesive layer 92 thereby exposing the adhesive layer so that the layer can function to secure the compressing sheet 94 to the underlying carrier sheet 90 as shown in FIG. 10C. Although the adhesive layer of fastening layer is comprised of disconnected adhesive segments 92, it would be possible to use other configurations of adhesive intermediate flap members 88 including a single connected adhesive grid extending over substantially the entire surface of the carrier sheet 90 intermediate the flap members.

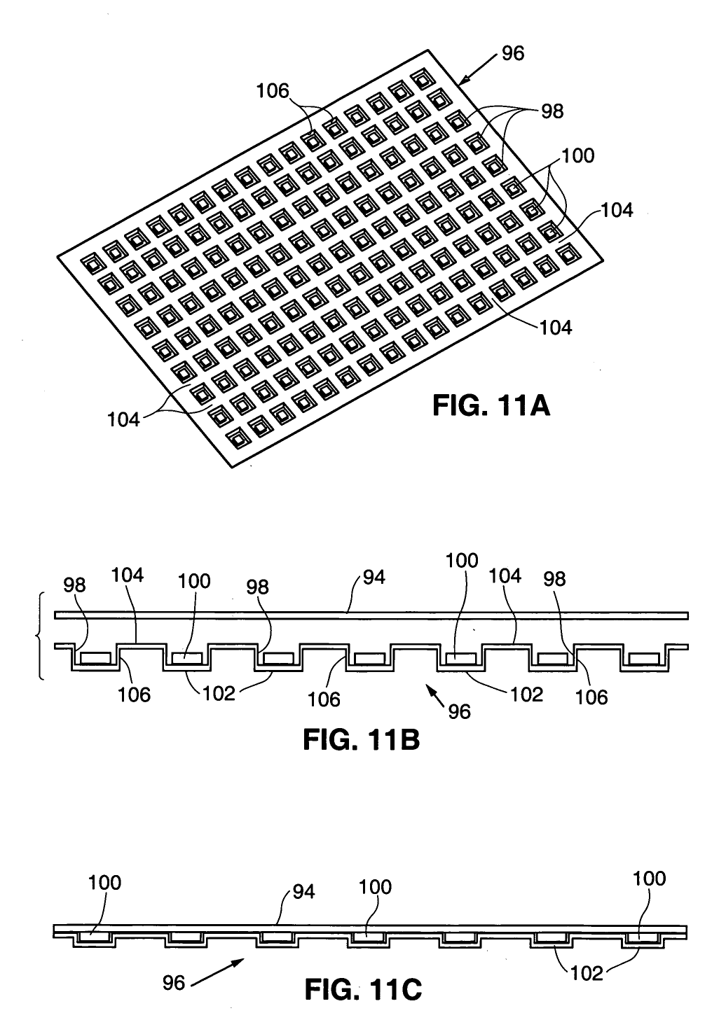

A further fastening layer embodiment is shown in FIGS. 11A, 11B and 11C. This embodiment, sometimes referred to as the well type fastening layer 96, also uses part of the underlying carrier sheet to form the support structure. The well fastening layer 96 includes an array of wells 98 (not all designated) typically created by deforming the carrier sheet. The wells 98 are arranged in an array, with the well density typically being at least one well for each square inch of fastening layer area and preferably approximately 25 wells for each square inch of area. A segment 100 of pressure sensitive adhesive is disposed in each well 98, with the adhesive segments together forming a layer of pressure sensitive adhesive. The bottom portions 102 of the wells together form the carrier sheet upon which the fastening layer 92 is disposed.

The fastening layer 96 includes a support structure which includes the raised region 104 intermediate the wells and the well wall members 106 (not all designated) which extend up from the surface supporting the adhesive segments 100 and past the upper surface of the adhesive segments. Thus, when a generic compressing sheet 94, such as a photograph, is resting on the fastening layer 96, the support structure, which includes raised region 104 and wall members 106, prevents the sheet from contacting the adhesive layer 100. Thus, the sheet 94 will not adhere to the underlying carrier sheet 102. However, should a substantial amount of pressure be applied to the compressing sheet 94, the support structure 104/106 will be displaced so that the upper surface of the adhesive layer formed by pressure sensitive adhesive segments 100 will contact sheet 94 as shown in FIG. 11C. Thus, the sheet 94 is secured to the underlying carrier sheet formed by well bottom portions 102.

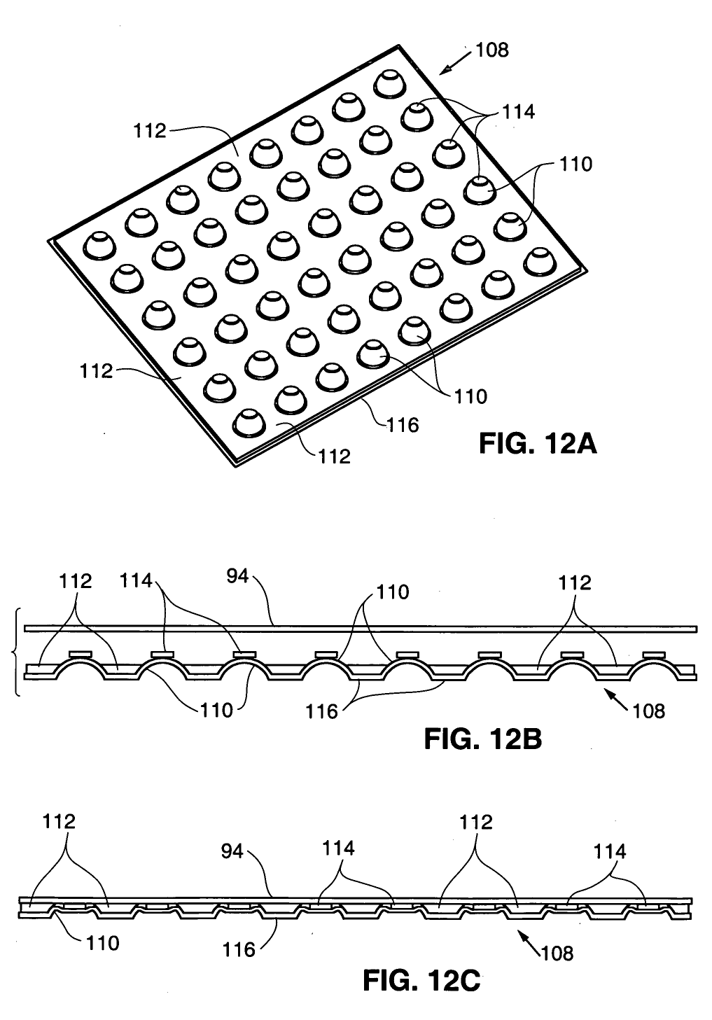

A still further fastening layer embodiment 108 is shown in FIGS. 12A, 12B and 12C. This embodiment, sometimes referred to as the raised area type fastening layer 102, also uses part of the underlying carrier sheet for part of the support structure. Fastening layer 108 includes an array of raised areas 110 (not all designated) typically created by deforming the carrier sheet. The raised areas 110 are arranged in an array, with the raised area density typically being at least one raised area for each square inch of fastening layer area and preferably approximately 25 raised areas for each square inch of area. The regions intermediate the raised areas 110 form the carrier sheet 116. A layer 112 of pressure sensitive adhesive is supported on the carrier sheet 116, extending around each of the raised areas 110.

The fastening layer 108 includes a support structure which includes the raised regions 110 in combination with a separate support member 114 supported on each raised member. The support members 114 are preferably made from material having a silicone treated surface and are solid so that they do not compress when typical forces are applied in the press. Each support member is held in place by a thin layer of pressure sensitive adhesive (not depicted) which can be an extension of adhesive layer 112. The upper surfaces of the support members 114 initially extend past the upper surface of the adhesive layer 112. Thus, when a generic compressing sheet 94, such as a photograph, is resting on the fastening layer 108, the support structure, raised regions 110 and support members 114, prevent the sheet from contacting the adhesive layer 112. Thus, the sheet 94 will not adhere to the underlying carrier sheet 116. However, should a substantial amount of pressure be applied to the compressing sheet 94, the support structure 114/110 will be displaced, with the support members 114 functioning to collapse the associated raised areas 110. This results in the upper surface of the adhesive layer 112 contacting sheet 94 as shown in FIG. 12C. Thus, the sheet 94 is secured to the underlying carrier sheet 116.

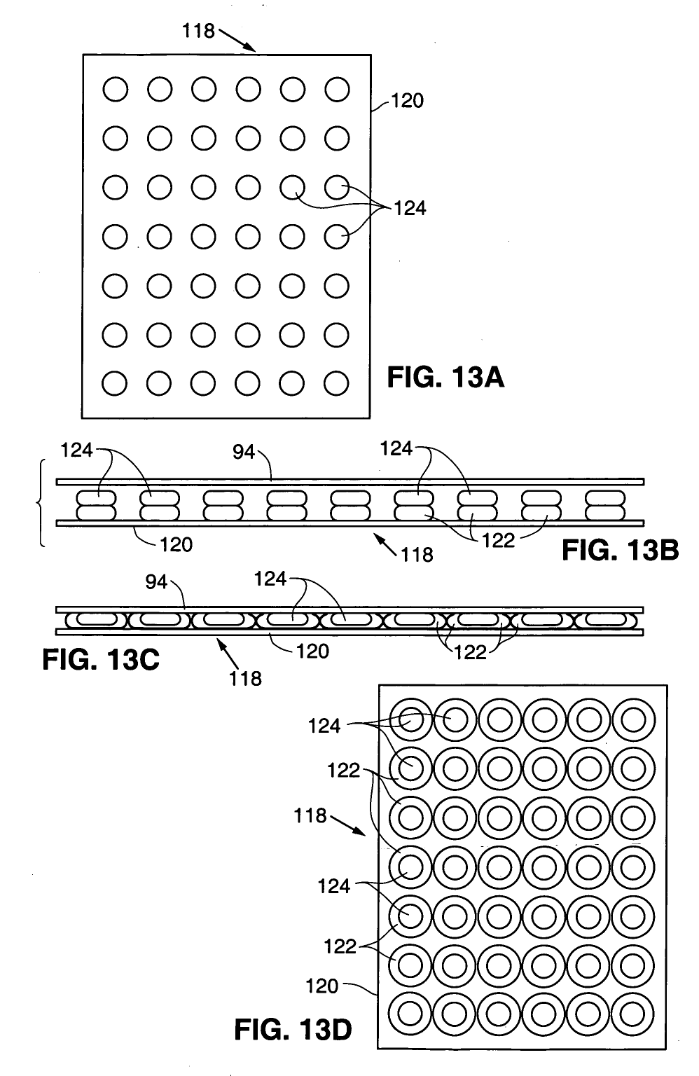

As still further embodiment fastening layer 118 is shown in FIGS. 13A, 13B, 13C and 13D. Unlike the previous embodiments, this embodiment utilizes a support structure that is separate from the underlying carrier sheet 120. As can best be seen in FIG. 13B, an array of spaced-apart pressure sensitive adhesive segments 122 is positioned over the surface of the carrier sheet 120, with the array having a density of at least one segment per square inch of carrier sheet 120 area and preferably approximately 25 segments per square inch. The array of segments 122 forms a layer of pressure sensitive adhesive. The support structure includes an array of support members 124, much like support members 114 of the FIG. 12A embodiment. A support member 124 is disposed over each of the adhesive segments 122. When a generic compressing sheet 94, such as a photograph, is resting on the fastening layer 118, the support members 124 initially prevent the sheet 94 from adhering to the adhesive layer. The thickness of the layer formed by adhesive segments 122 is preferably about 4 mils.

However, when a substantial compression force is applied through the compressing layer, the support members 124 are forced down into the associated adhesive segment 122. As can best be seen in FIGS. 13C and 13D, the downward displacement of the support members causes the adhesive segments 122 to expand laterally, with the gaps between the segments providing space for this expansion. The net result is that the upper surface of the support members 124 falls below the upper surface of the adhesive layer so that the compressing sheet 94 becomes secured to the adhesive layer and underlying carrier sheet 120.

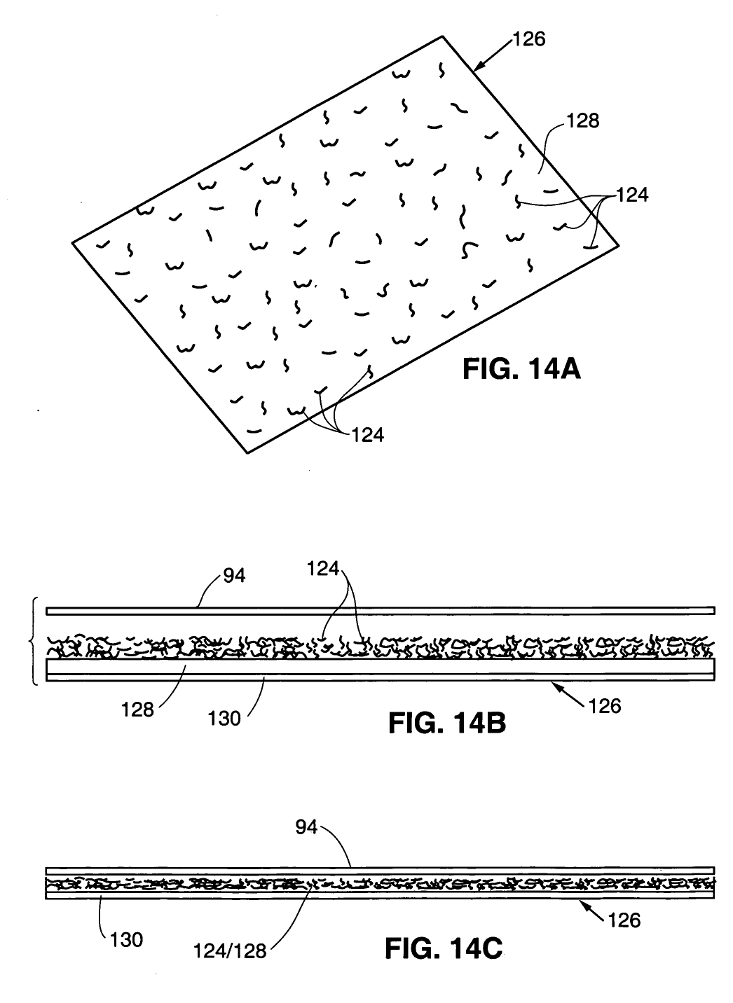

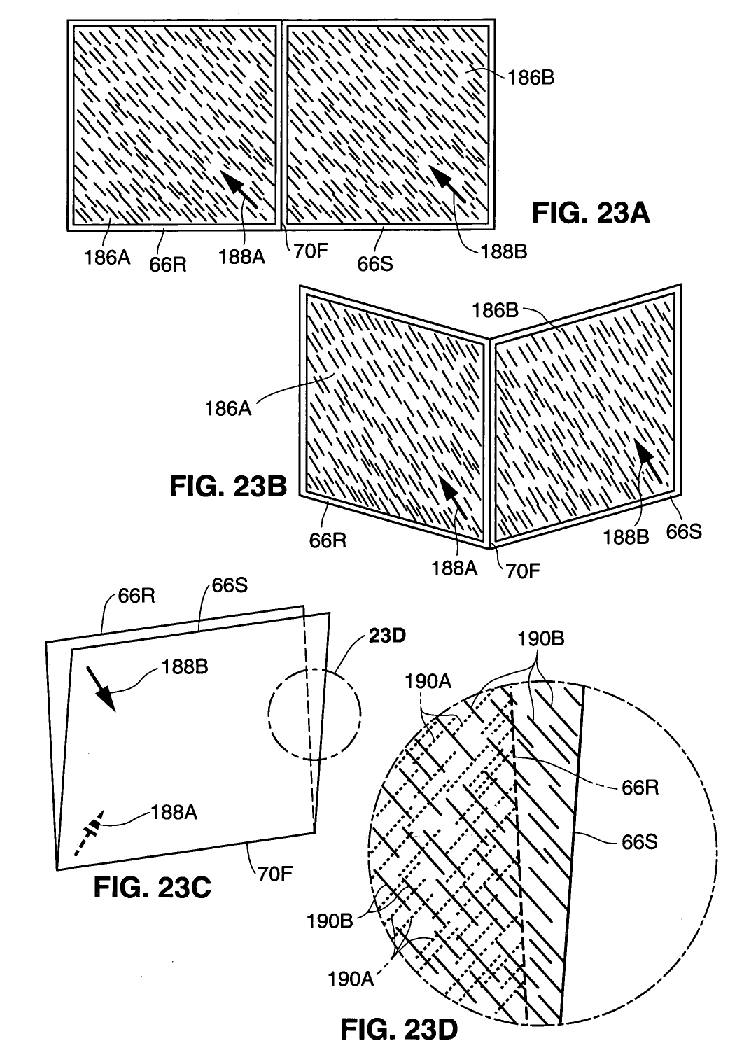

Continuing, a further alternative fastening layer 126 is shown in FIGS. 14A, 14B and 14C. As shown in FIG. 14B, the fastening layer 126 is supported on a carrier sheet 130 and a layer of pressure sensitive adhesive 128 extending over the carrier sheet. A layer of non-woven fabric 124, typically in the form of loosely coupled individual fibers, is disposed over the adhesive layer 128 to form the support structure. The fibers could also be separate fibers such as flock. Layer 124 could also comprise woven fabric that is highly porous such as cheesecloth. Depending upon the thickness of the woven fabric, it may be necessary to increase the thickness of the pressure sensitive adhesive layer 128 to about 4 mils. When a generic compressing sheet 94, such as a photograph, is resting on the support structure 124, the fibers of the structure that are present on the upper surface of adhesive layer 128 prevent the sheet from significantly adhering to the adhesive. Further details regarding the use of flock for the support structure will be provided in connection with the discussion relating to FIGS. 23A-23D.

When a substantial compression force is applied, the fibers in layer 124 are forced into the adhesive layer 128 as can be seen schematically in FIG. 14C so that a substantial portion of the adhesive is exposed so that it can contact compressing sheet 94. Thus, sheet 94 is secured to the underlying carrier sheet 130 by way of the adhesive.

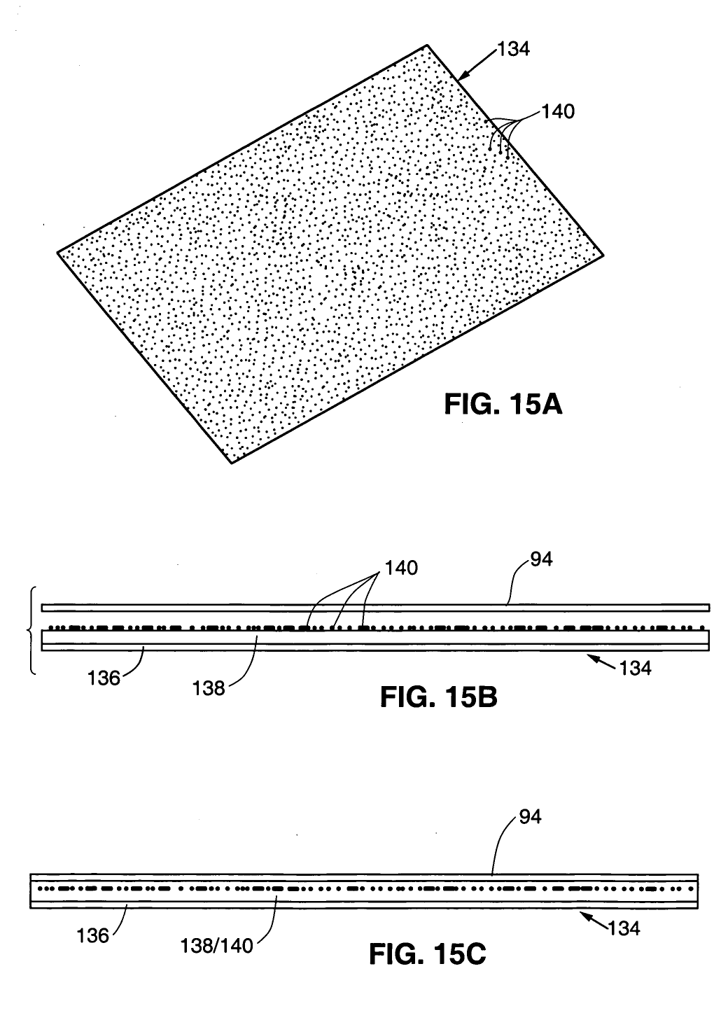

An additional fastening layer embodiment 134 is depicted in FIGS. 15A, 15B and 15C. As can best be seen in FIG. 15B, fastening layer 134 is supported on a carrier sheet 136 which supports a layer 138 of pressure sensitive adhesive. A layer 140 of granulated material such as sand, pumice, diatomaceous earth or talcum powder, functions as the support structure. The granules 140 are positioned at the upper surface of the adhesive layer 138 and prevent a generic compressing sheet 94 from contacting the adhesive layer when the compressing sheet is merely resting on the fastening layer 134. However, when a substantial compression force is applied through the compressing sheet, the granules are displaced from the upper surface and forced down into the adhesive layer as can be seen schematically in FIG. 15C. This results in a quantity of the pressure sensitive adhesive 138 being in a position to contact the compressing sheet 94 thereby securing the compressing sheet to the carrier sheet 136.

The various embodiments of pressure sensitive adhesive based fastening layers disclosed herein are particularly suitable for the present application of securing photographs to a carrier. First, it is important that the adhesion strength of the fastening layers be small at applied forces expected to be incurred during shipping of the carrier assembly 60 (FIG. 5B) and during assembly when photographs 68 are positioned on the carrier assembly and when the assembly is transferred to the press 78 (FIGS. 8A and 8B). Second, it is important that the adhesion strength be substantial after the fastening layer is activated by application of a relatively large force such as is provided by press 78.

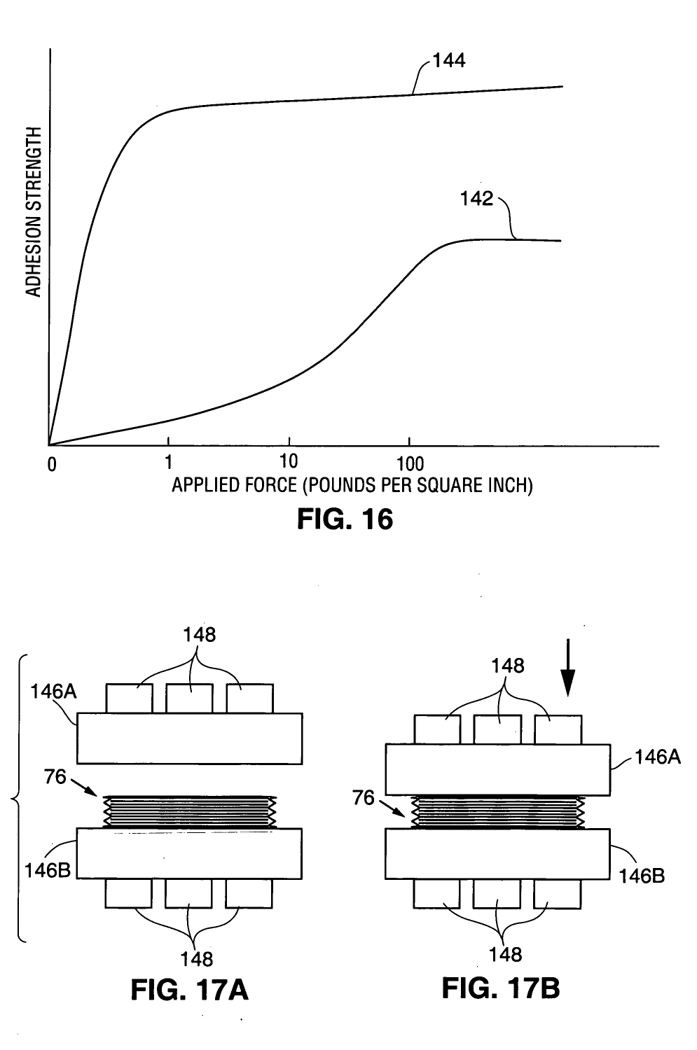

FIG. 16 is a graph having a curve 142 illustrating the adhesive qualities of an exemplary fastening layer 82 showing adhesion strength versus applied force per unit area. Also shown for purposes of comparison is a curve 144 for an exemplary conventional pressure sensitive adhesive. It can be seen from curve 144 that the conventional adhesive provides a relatively large amount of adhesion strength for small amounts of applied force, with the adhesion strength not increasing significantly for large amounts of applied force. The subject fastening layer exemplary curve 142 provides an insignificant amount of adhesion strength at low applied force, with increases in force resulting in a corresponding increase in adhesion strength. It can be seen that a conventional pressure sensitive adhesive provides significantly greater adhesion strength than does the subject fastening layer after application of substantial compression forces. The final adhesion strength is sufficient for many applications, such as those described herein, so the smaller strength is not a significant shortcoming.

The shape of curve 142 can be readily adjusted depending upon the type of fastening layer and depending upon the manner in which the fastening layer is implemented. By way of example, for the embodiment of FIGS. 10A, 10B and 10C, the slope of the curve 142 will be somewhat steeper once the adhesive layer starts becoming activated as compared to the FIGS. 14A, 14B and 14C embodiment 126. That is, the rate of increase in adhesion strength is generally larger. Also, the maximum adhesion strength of fastening layer 82 can be increased by increasing the total area and number of the adhesive segments 92. The point at which fastening layer is activated, that is, the point at which the adhesion strength becomes significant can be reduced or increase by changing the number of flap members 88. The activation point can also be increased or decreased by selecting carrier sheet materials 90 of greater or lesser resiliency. Equivalent adjustments could also be made, for example, to the fastening layer 96 (FIGS. 11A, 11B and 11C) and fastening layer 108 (FIGS. 12A, 12B and 12C). As a further example, the point at which the fastening layer embodiment 126 (FIGS. 14A, 14B and 14C) and embodiment 134 (FIGS. 15A, 15B and 15C) are activated can be adjusted by altering the volume of fabric 124 or volume of granulated material 140 or the physical properties of these items along with the thickness of the respective adhesive layers 128 and 138.

The fastening layers, when used in applications for fabricating photo-albums and the like, preferably have adhesion properties such that the adhesion strength increases by at least a factor of 10 when applied compression force of 2.0 pounds per square inch is increased to 25.0 pounds per square inch. Of course, the actual compression force applied to the various embodiments of the fastening layer during use can vary depending upon various factors including the manner in which the layer is actually implemented. For example, a fastening layer having the above-noted adhesion properties may be secured using a force less than or greater than 25.0 pounds per square inch.

As previously described, a hardcover assembly can be applied by way of the pressure sensitive adhesive based fastening layers, such as layer 64B of FIGS. 6A and 6B. In that event, the loaded carrier assembly 76 is installed between the front and rear hardcover sections 36A and 36B (FIG. 9) prior to placing the carrier assembly in the press 78. Alternatively, the hardcover assembly can be applied after the carrier assembly 76 has been compressed. Rather than using the fastening layers 64 for securing the hardcover assembly, the assembly is provided with layers 182A and 182B of conventional pressure sensitive adhesive being disposed on the interior sides of the front and rear covers 36A and 36B as shown in FIG. 20. Release liners (not depicted) cover the pressure sensitive adhesive prior to assembly. Such an arrangement is shown, for example, in Patent Application Publication US 2004/0067123 A1 published Apr. 8, 2004 based upon application Ser. No. 10/385,960 filed on Mar. 10, 2003, the contents of which are fully incorporated herein by reference. Preferably, a pair of end leaves 176A and 176B are provided as shown schematically in FIG. 20 which are positioned on opposite sides of the loaded carrier assembly prior to the compression step. End leave 176A is folded to provide two end sheets 178A and 178B, each of which is essentially the same size as the individual carrier sheets 66 of the assembly upon which the photographs are to be secured. Similarly, end leave 176B is folded to provide two end sheets 180A and 180B. The end leaves 176A and 176B are positioned on opposite sides of the carrier assembly with the outer carrier sheets each being provided with a fastening layer 64B which faces end sheet 178B and fastening layer 64N which faces end sheet 180B of the corresponding end leave.

With the loaded carrier assembly 76 and end leaves 176A and 176B held in position, the arrangement is placed in the plate 78B of the press so that a compressing force can be applied as previously described. The fastening layers are thus activated thereby securing the photographs and carrier sheets together and also securing leaves 178B and 180B to the assembly 76. A hardcover, including front and back cover sections 36A and 36B and spine section 36C is then applied to the bound combination as described in detail in the above referenced Patent Application Publication US 2004/0067123 A1. As previously noted, the interior surface of the front cover section 36A and the interior surface of the back cover section 36B are both covered with a layer of respective pressure sensitive adhesive 182A and 182B, with the layers of adhesive completely covered by respective release liners (not depicted). During this process of installing the assembly 76 and end leaves 176A/B in the hardcover assembly, end leave sheet 178A is attached to front cover section 36A by removing the release liner and carefully positioning assembly 76 and end leaves 176A/B, collectively the stack, over the front cover section so that sheet 178A will be completely adhered to cover section 36A by the pressure sensitive adhesive 182A. Sheet 180A is then applied to cover section 36B by removing the release liner from section 36B and folding the section over the bound assembly so that sheet 180A is contacted by the exposed pressure sensitive adhesive 182B on the inner surface of rear cover section 36B. Preferably a guide apparatus is used in this process as also disclosed in the above-noted Patent Application Publication US 2004/0067123 A1 since it is very difficult to reposition the stack to be bound once part of the stack has contacted the pressure sensitive adhesive. When completed, the bound stack is secured to the hardcover assembly only by way of the end leaves 176A and 176B.

FIG. 21 shows an alternative hardcover assembly that includes front and back relatively rigid cover sections 36A and 36B and an intermediate spine section 36C. Typically the front and back cover sections are secured together by a flexible membrane 37 such as fabric or the like. Rather than utilizing a pressure sensitive adhesive located on the interior surface of the hardcover assembly as previously described in connection with FIG. 20, the hardcover assembly is provided with two of the previously described pressure sensitive adhesive based fastening layers 64 as shown in FIG. 21. In that event, the loaded carrier assembly 76 is positioned intermediate end leaves 176A/B. That arrangement is then accurately positioned over the fastening layer 64 on the front cover section 36A so that sheet 178A contacts the fastening layer. This step is greatly simplified since the assembler does not have to contend with aggressive pressure sensitive adhesive during the positioning. Next, the rear cover section 36B is folded over onto the stack so that the fastening layer 64 on section 36B will contact sheet 180A. Again, accurate positioning is not difficult since the fastening layer is not tacky at this stage. Thus, the need for the previously described guide apparatus is reduced or even eliminated. The entire assembly is then positioned in the press so that all of the fastening layers will be activated thereby securing the various components together, including securing the end sheet 178A to cover section 36A and securing end sheet 180A to cover section 36B. The hardcover assembly of FIG. 21 could also be used for covering other bound stacks assembled using conventional binding methods rather than the disclosed pressure sensitive adhesive based fastening layers.

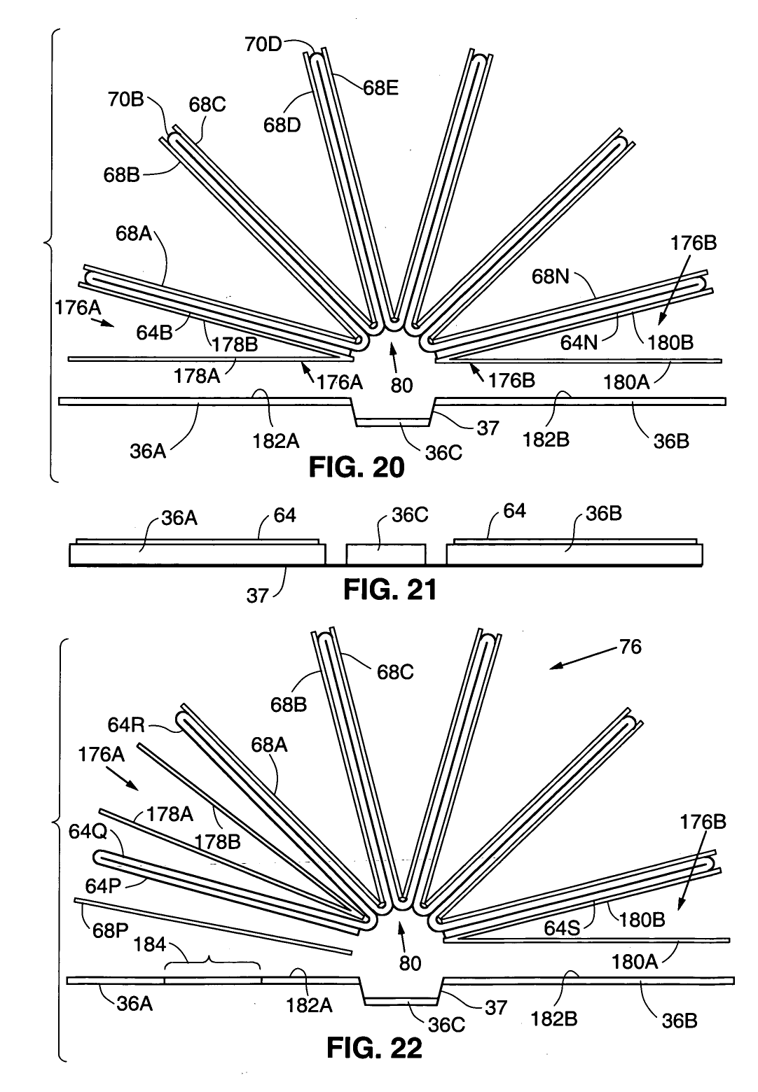

It is also possible to produce a photograph album or the like where a photograph can be viewed through an opening or window formed in the front cover section of the hardcover assembly. As can be seen in FIG. 22, a hardcover assembly is provided with a window 184 in the front cover section 36A. A photograph 68P is provided, with the photograph having an image sized and positioned so that it can be viewed through window 184 when the photograph is correctly positioned over the inner surface of the front cover section 36A. The carrier assembly includes one page formed by two folded carrier sheets, with each sheet having an associated fastening layer 64P and 64Q. As shown in FIG. 22, an end leave 176A is positioned intermediate to adjacent pages of the carrier assembly so that sheet 178A is facing fastening layer 64Q and so that sheet 178B is facing another fastening layer 64R of an adjacent carrier assembly page. A second end leave 176B is positioned intermediate the front cover section 36B and a page of the carrier assembly supporting a fastening layer 64S.

The loaded carrier assembly 76, end leaves 176A and 176B, together with photograph 68P, are arranged relative to one another as shown in FIG. 22 and manually forced together so that the arrangement can be placed in a press as shown in FIGS. 8A/B and compressed so that all of the fastening layers 64 are activated. Among other things, this action allows the photograph 68P to be displayed while being secured to end leave 178A by way of fastening layers 64P and 64Q. In addition, fastening layer 64S functions to secure end sheet 180B to the last page of the bound carrier assembly. The bound arrangement is then positioned in the hardcover assembly in the same manner as previously described in connection with FIG. 20. Thus, the image surface of photograph 68P is secured to the inner surface of front cover assembly 36A by the pressure sensitive adhesive layer 182A, except where the viewing window 184 is located. In addition, end leave sheet 178A is secured to the rear of photograph 68P by way of fastening layers 64P and 64Q. Similarly, end leave sheet 180A is secured to the inner surface of back cover section 36B by way of pressure sensitive adhesive 182B. It would also be possible to substitute the carrier assembly of FIG. 22 utilizing pressure sensitive adhesive layers 182A and 182B with fastening layers as previously described in connection with FIG. 21. In that event, the entire arrangement, including the hardcover assembly, is placed in the press for activating all of the fastening layers.

As previously described in connection with the fastening layer embodiment 126 of FIGS. 14A/B/C, fibers can be used to form the support structure of the fastening layer. Flock has been found to be particularly suitable for this application. Flock in the form of precision cut monofilament micro-fibers of cotton, rayon or acrylic can be used. The diameter of the individual flock strands is only a few thousandths of a centimeter, with the length typically ranging from 0.25 to 5 mm. A quantity of flock is evenly applied to the underlying layer of pressure sensitive adhesive so that part of the flock is attached to the layer. A soft brush can then be used to remove the excess flock. FIGS. 23A/B/C/D depict an exemplary pair of carrier sheets 66R and 66S connected by a fold 70F, with this arrangement forming all or part of a carrier assembly. Each carrier sheet 66R and 66S is provided with a respective fastening layer 186A and 186B which includes flock for the support structure, with the length of the fibers being greatly exaggerated for purposes of clarity. As previously explained, the fastening layers are implemented to provide little adhesion strength at low pressures so that, for example, a photograph can easily be positioned and repositioned. However, when the carrier arrangement is folded as shown in FIG. 23C for shipping and the like there may be some tendency for the layers 186A and 186B to adhere to one another. This tendency can be reduced by applying the flock to the adjacent carrier sheets such as sheets 66R and 66S so that fibers are ideally aligned at right angles to one another. The orientation of the flock fibers can be controlled by using fibers covered with a conductive coating and then depositing the fibers on the pressure sensitive adhesive layer using well known electrostatic application processes. As a result, the deposited fibers all tend to be positioned standing upright. Next, the upright fibers are then by brushing the fibers with a brush in a single direction. For reasons that will be explained, the directions should be other than parallel to fold 70F. By way of example, the fibers of fastening layer 186B are brushed in a direction indicated by arrow 188B, with the direction being about 45 degrees towards the fold 70F. This tends to orient the fibers in the direction of the arrow 188B. Similarly, the upright fibers of fastening layer 186A are brushed in the direction of arrow 188A which is a direction of about 45 degrees away from fold 70F. When the carrier sheets 66R and 66S are folded over one another as shown in FIG. 23C as they would be, by way of example, in shipping, the fibers tend to be normal to one another as represented in FIG. 23D. The fibers 190B from fastening layer 186B, which are represented by relatively thick lines, are generally at right angles to fibers 190A from fastening layer 186A, with the fibers 190A being represented by relatively thin lines. Any deviation of fiber orientation from random will provide some benefit, with the orientation preferably being between 70 and 90 degrees for a majority of the fibers on the opposing fastening layers. If the fibers are brushed in a direction parallel to the fold 70F, it can be seen that fibers of the two sheets will remain parallel, something not desired, when the sheets are folded.

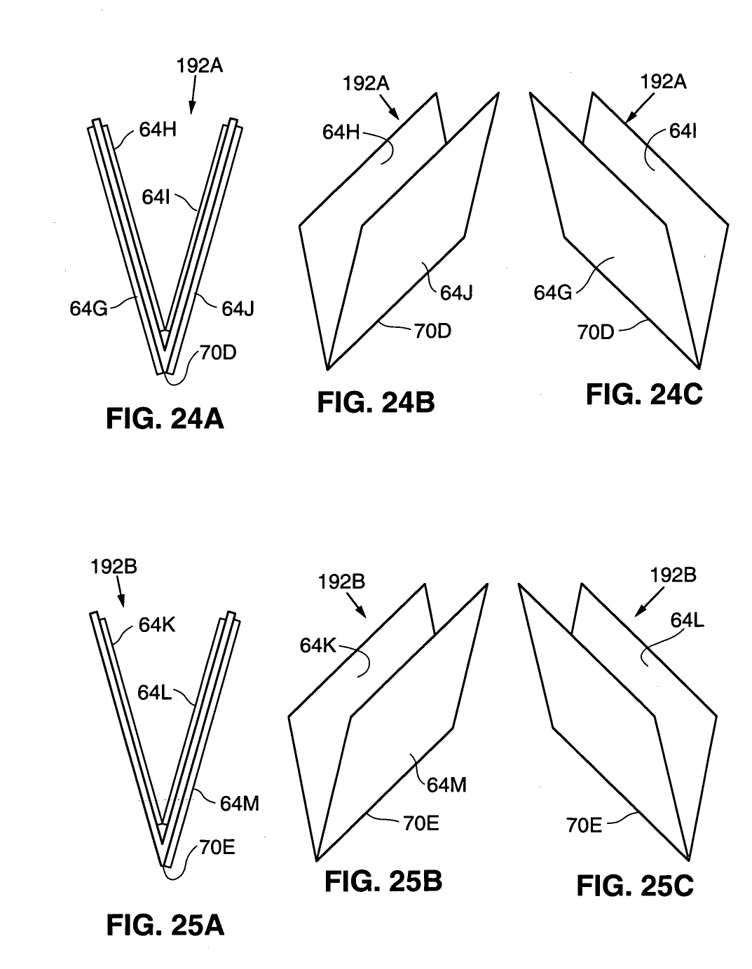

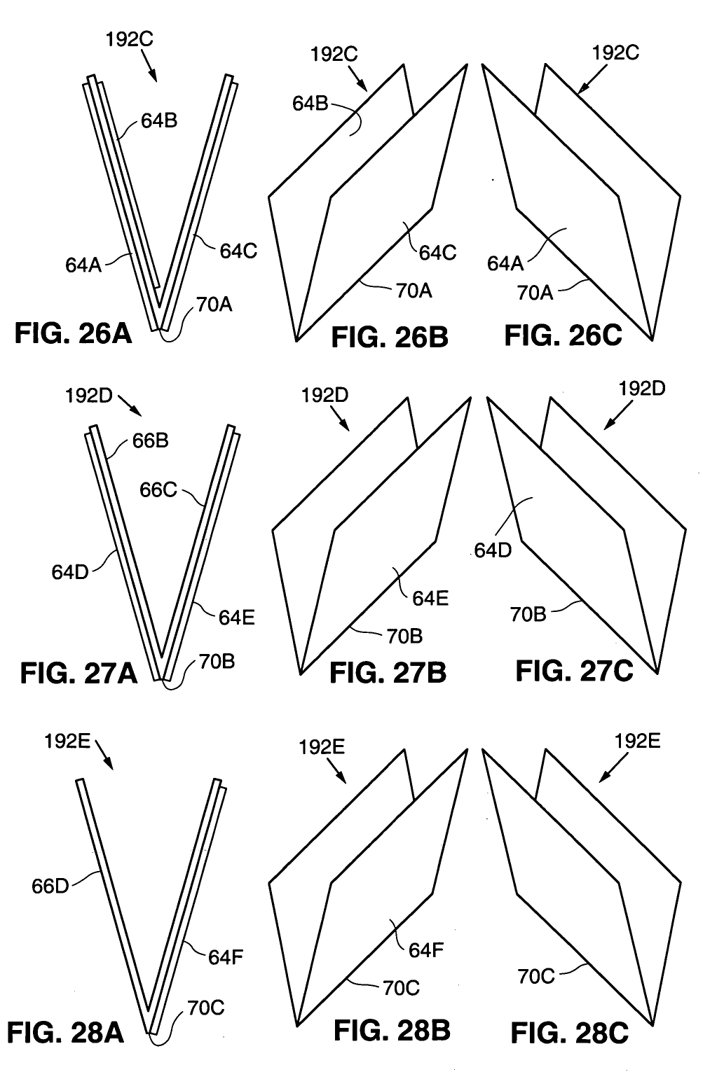

Although a carrier assembly 60 having more than two sheets 66, such as FIG. 5B, has been described, it would be possible to create an album using a collection of one or more carrier assemblies, with each of the assemblies including only two sheets separated by a fold. As will be seen, two sheet carrier assemblies can be implemented in differing manners so that a wide variety of photo-albums can be created. FIGS. 24, 25, 26, 27 and 28 depict five different two sheet carrier assemblies which can be combined to create different photo albums. FIGS. 24A, 24B and 24C show a carrier arrangement 192A having two sheets (not designated) separated by a fold 70D. Carrier sheet arrangement 192A includes fastening layers 64G, 64H, 641 and 643 located on respective sides of both sheets. FIGS. 25A, 25B and 25C show a carrier arrangement 192B having two sheets (not designated) separated by a fold 70E. Carrier sheet arrangement 192B includes fastening layers 64K on the inner side of one sheet and layers 64L and 64M on both sides of the other sheet. Continuing, FIGS. 26A, 26B and 26C show a carrier sheet arrangement 192C having a fastening layer 64A and 64B on both sides of one sheet and a layer 64C on the outer side of another sheet. FIGS. 27A, 27B and 27C show a carrier sheet arrangement 192D having fastening layers 64D and 64E located on the outer side of both sheets. Finally, a carrier sheet arrangement 192E is shown in FIGS. 28A, 28B and 28C where only a single fastening layer 64F is used, with the fastening layer being disposed on the outer side of one of the sheets.

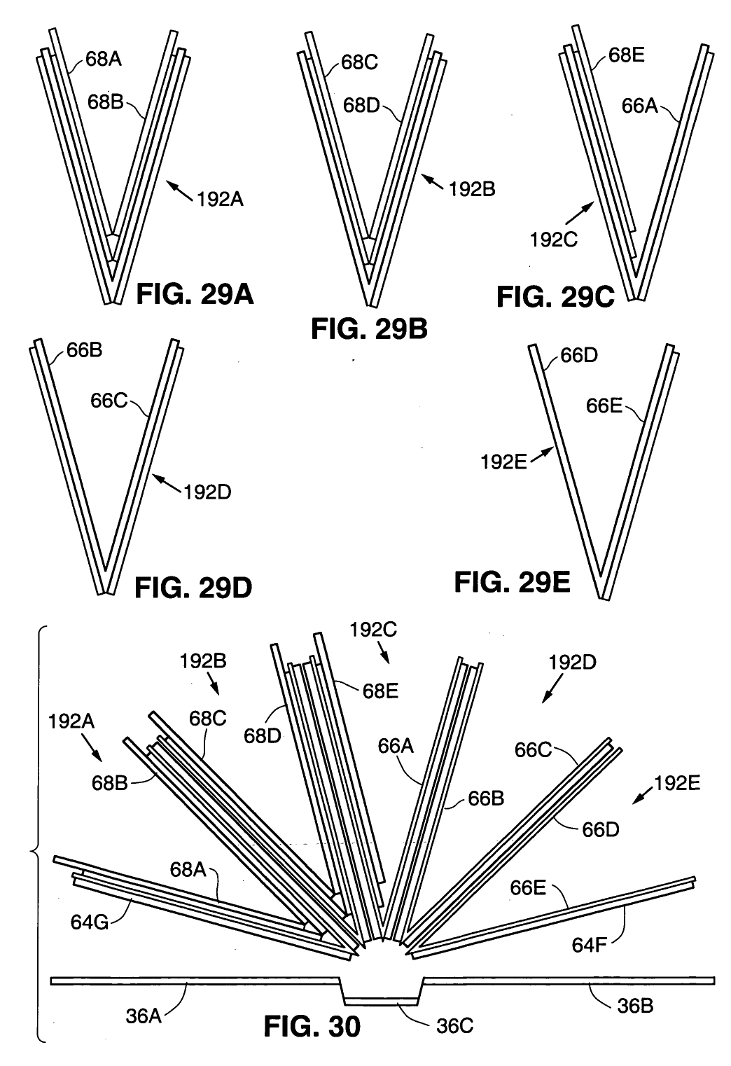

FIGS. 29A, 29B, 29C, 29D and 29E illustrate one example for using the five previously described carrier assemblies 192A/B/C/D/E. Photographs 68A and 68B are shown positioned on the inner fastening layers of assembly 192A, photographs 68C and 68D are shown positioned on the inner fastening layers of assembly 192B, photograph 68E is shown positioned on the one inner fastening layer of assembly 192C, with assemblies 192D and 192E having no photographs. The loaded carrier assemblies of FIGS. 29A-29E are positioned relative to one another as shown. The carrier assembly arrangement is then positioned within a hardcover assembly as shown in FIG. 30, with this assembly having no adhesive on the inner surfaces of the front and back cover sections 36A and 36B. The loaded carrier assembly and hardcover assembly are then positioned in a press and compressed thereby activating the various fastening layers. Thus, layer 64G will secure the assembly to the inner surface of the front cover section 36A and fastening layer 64F will secure the assembly to the inner surface of the back cover section 36B. The fastening layers intermediate the five carrier assemblies 192A-192F function to secure the assemblies together, with the fastening layers located adjacent the photographs functioning to secure the photographs to the carrier assembly. The bound album of FIG. 30 is intended to illustrate one application for the five carrier assemblies, with the particular arrangement shown not being that useful for an actual photo-album. Whatever combination or order is used, it is important that at least one fastening layer be located between adjacent ones of the carrier assemblies to that the adjacent assemblies will be secured together when the layers are activated by application of pressure. Also, it is sometimes preferable to connect adjacent carrier assemblies using only a single fastening layer. For example, sheets 66A and 66B of carrier assemblies 192C and 192D are shown connected together by redundant fastening layers whereas sheets 66C and 66D of assemblies 192D and 192E are connected to by only a single fastening layer. Thus, the page formed by sheets 66C and 66D may, depending upon the manner in which the fastening layers are implemented, provide an thinner and perhaps more attractive page than do sheets 66A and 66B. Carrier assembly 192E, having only one fastening layer, can be used where appropriate to eliminate redundant fastening layers.

Carrier assembly 192A is one of the most useful of the assemblies since one or more can function to display two, four, six or more photographs as desired. When assembly 192C is added, an attractive album having an odd number of photographs can be created and to allow a photograph to be displayed opposite a blank page. One or two assemblies 192C can also be used where it is desired that all photographs be located on album pages rather than being secured directly to the front or rear cover section. For example, assembly 192A is shown in FIG. 30 attaching photograph 68A directly to the inner surface of front cover section 36A. Assembly 192C could be used instead of assembly 192A so that carrier sheet 66A (FIG. 29C), which does not support a photograph, is secured to the front cover section 36A. In that event, assembly 192A or 192B could be used to support additional photographs. Assembly 192C can also being used in connection with the back cover section 36B if a photograph is not to be secured to the inner surface of that section.

Although FIG. 30 shows a hardcover assembly which relies upon the fastening layers 64G and 64G of the carrier assembly for securing the assembly to the hardcover, it would also be possible to utilize a conventional hardcover assembly such as described in connection with FIG. 20 which uses pressure sensitive adhesive layers covered by release liners together with end leaves 176A and 176B. In that event, assembly 192E could be used to replace one or both of these end leaves.

The characteristics of the fastening layers disclosed herein also enable the assembler to produce a proof of the album. The loaded carrier assembly 76 and end sheets if appropriate and hardcover assembly if appropriate, are placed in press 78A/78B, with the press applying a substantially reduced force of only a few pounds per square inch. The components of the loaded carrier assembly are weakly secured together so that the assembly can be fully examined without upsetting the assembly. If adjustments need to be made, the assembly can be adjusted, including repositioning of one or more photographs without damaging the photographs. Once the proof is satisfactory, the assembly can then be returned to the press for a normal compression cycle of typically 50 to 100 pounds per square inch as previously described.

It should also be noted that those fastening layers 64 where the support structure is implemented using part of the underlying carrier sheet 66 are somewhat more restricted in their application as compared to those fastening layers where the support structure is separate from the carrier sheet. By way of example, the FIG. 6A loaded carrier assembly 76 includes a carrier sheet 66B having a fastening layer 64D on one side and another fastening layer 64C located on the other side. If, for example, the fastening layer embodiment 82 of FIGS. 10A, 10B and 10C were utilized in this application, it can be seen that care must be taken in locating the hinged flap members 88 in the common carrier sheet 64 (or 64B of FIG. 6C) so that one group of flap members functions to provide the support structure function for fastening layer 64C and another group of flap members function to provide support structure for fastening layer 64D. Clearly, the same region of the carrier sheet for providing a flap member for layer 64C cannot be used to provide a flap member for layer 64D. In order to avoid this potential problem, it may be preferable to avoid using this embodiment of fastening layer for layer 64D (and 64E) and other similarly situated fastening layers by manufacturing the carrier assembly with the back sides of carrier sheets 66B and 66C adhered together using a conventional adhesive. This manufacturing option was previously described. In that case, fastening layer 64D is not needed so that fastening layer 64C can be implemented using embodiment 82 or embodiments 96 (FIGS. 11A, 11B and 11C) or embodiment 108 (FIGS. 12A, 12B and 12C). This issue is not present for those fastening layer embodiments that utilize a support structure independent of the underlying carrier sheet such as embodiment 118 (FIGS. 13A, 13B, 13C and 13D), embodiment 126 (FIGS. 14A, 14B and 14C) and embodiment 134 (FIGS. 15A, 15B and 15C).

As previously described, the fastening layers 64 (FIG. 5B) could also be implemented using heat activated adhesives rather than being based upon pressure sensitive adhesive. A heat activated adhesive marketed by National Starch and Chemical under the name Cool Bind 1300 has been found satisfactory for this application. The carrier assembly of FIG. 5B is loaded with photographs 68 in the same manner as previously described in connection with FIG. 7. Once the photographs have been loaded, the loaded carrier assembly 76 is positioned in a heated press as shown in FIG. 17A. This is done without the hardcover assembly. The press is closed over the assembly 76 as shown in FIG. 17B, with both the top and bottom plates 146A and 146B being provided with heating elements. The press is closed on the assembly so as to provide both heat and pressure. A pressure of approximately 5 pounds per square inch has been found to be suitable. A temperature sensor could be positioned in the center of the assembly 76 so that it can be determined when the interior of the assembly 76 has reached the desired temperature to ensure that the heat activated adhesive fastening layers have all been activated. The maximum temperature of the heating elements is limited so as to not damage the photographs being bound. A maximum temperature of approximately 200 degrees Fahrenheit has been found suitable for most applications. Pressure continues to be applied once the heating elements have been turned off to ensure a strong and uniform bond is made between all of the photographs and the underlying carrier sheets as the assembly cools. The press is provided with an array of cooling fans 148 located on both the upper and lower plates of the press to shorten the cooling time. Once the assembly has cooled, a hardcover can then be applied in the conventional manner as previously described.

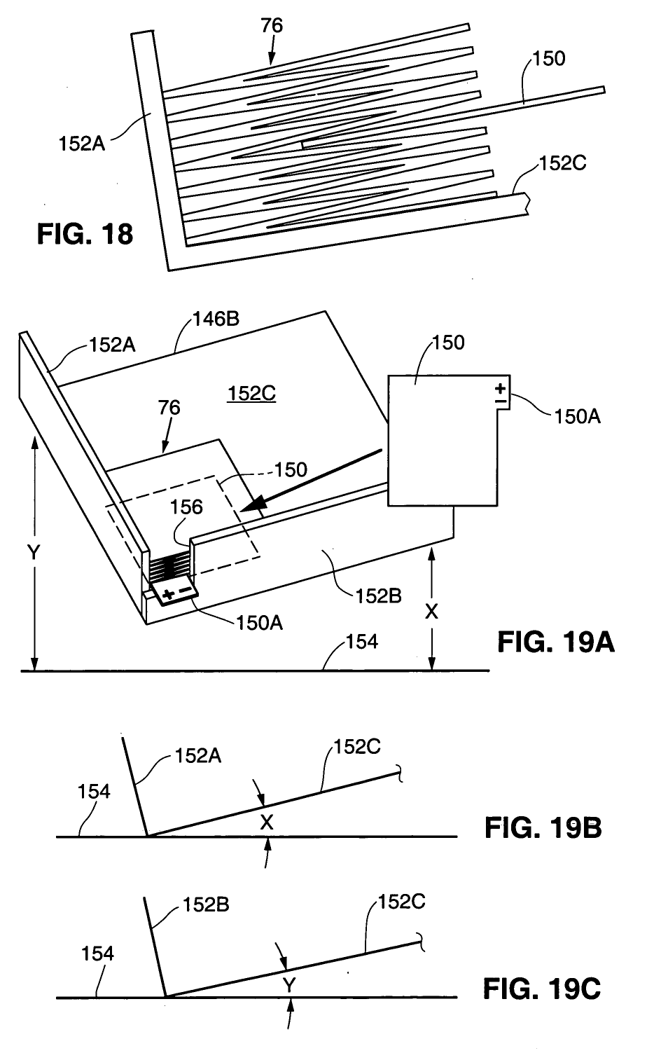

It is desirable to heat and cool the loaded carrier assembly quickly to as to shorten the assembly cycle time. As previously noted, cooling is facilitated by way of various cooling fans 148. It is also possible to shorten the heating time by adding one or more thin heating elements 150 as shown in FIGS. 18 and 19 that are inserted in the center (if only one is used) or in equally spaced locations if multiple heating elements are used, of the assembly 76. The thin heating elements 150, which can be implemented using conventional printed circuit board technology, are capable of withstanding the compression forces applied by the heating press. Heating elements utilizing etched foil technology manufactured by Minco have been found suitable for this application. Heating element 150 is preferably implemented to produce about 5.5 watts of power per square inch.

Preferably the bottom plate 146B, represented schematically in FIGS. 17A and 17B, includes an angled support surface 152C upon which the loaded carrier assembly 76 is positioned. Sidewalls 152A and 152B, which are perpendicular to one another, function to locate the assembly 76 on the bottom plate. Support surface 152C is preferably inclined downward with respect to a level plane represented by line 154 towards a sidewall 152B so that the assembly naturally rests against the sidewall. Surface 152C further is also preferably inclined downward so that assembly 76 rests against that sidewall. Line 154 represents a level plane, with the surface 152C being tilted with respect to the level plane 154 by an angle X (FIG. 19B) so that the assembly will tend to rest against sidewall 152A due to gravity. Similarly surface 152C is tilted down by an angle Y (FIG. 19C) with respect to the level plane so that the assembly will also tend to rest against sidewall 152B. Angles X and Y are both at least 5 degrees, with angle X preferably being approximately 20 degrees and angle Y preferably being approximately 30 degrees. Sidewalls 152A and 152B are perpendicular to one another, with angle X being measured along a line normal to sidewall 152A and with angle Y being measured along a line normal to sidewall 152B. Note that the upper plate 146A moves in an angled direction normal to surface 152C, with the compressing surface of the upper plate being parallel to the tilted lower compressing surface 152C. A cutout 156 is formed in sidewall 152B to accommodate the heater contact 150A or contacts if multiple heaters are used. An electrical cable (not depicted) is connected to connector 150A to provide power to the heater. It should be noted that the press for the pressure activated adhesive based fastening layers of FIGS. 8A and 8B could also employ a lower plate utilizing an angled support surface as described in connection with FIGS. 19A, B and C so that the assembly will be registered against sidewalls 152A and 152B by the force of gravity. Again, the upper plate 78A would move in a direction normal to the tilted support surface of the lower plate with the upper plate compressing surface remaining parallel to the tilted lower plate surface.

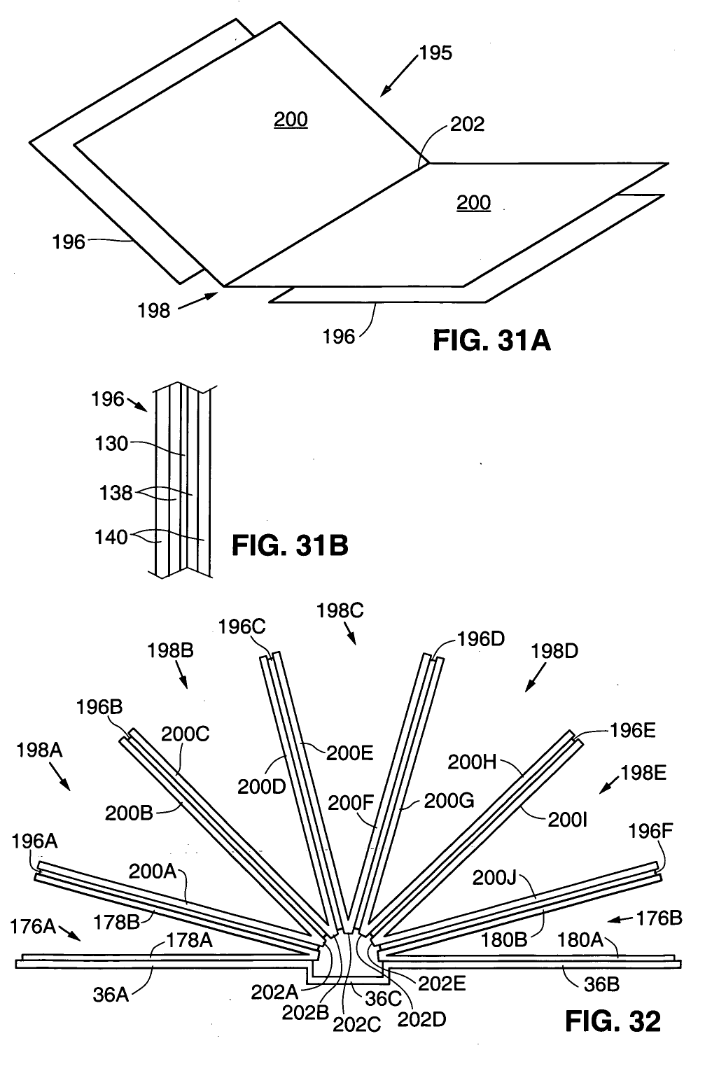

FIG. 31A depicts a still further alternative embodiment arrangement 195 which can be combined with other similar arrangements to create a photograph album as shown, by way of example, in FIG. 32. This approach utilizes a photograph 200 which is folded along a score or fold line 202 formed in the center of the photograph. Thus, one-half of a photograph 200 forms one side of a page of the album. Thus, if desired, photograph 200 may include two separate images separated by fold line 202. Multiple arrangements 195 are used to accommodate multiple photographs 200. A modified fastening layer 196 is also used to secure the arrangements 195 together. The fastening layers 196 are similar to the pressure sensitive adhesive based fastening layers previously described except the layers are two-sided so that the outer surfaces of adjacent arrangements 195 can be secured together. FIG. 31B is a cross-section of a portion of an exemplary fastening layer 196 and includes a center carrier sheet 130 similar to carrier sheet 130 of FIG. 14B. A layer of pressure sensitive adhesive 138 is disposed on opposite sides of the carrier sheet 130, with layer 138 being similar to layer 138 of FIG. 14B. Further, a support structure layer 140 is disposed over each of the adhesive layers 138. Support structure layer 140 could include, for example, some type of granulated material as previously described, such as sand or pumice, or other materials such as fibers or flock. Again, the objective is to provide a fastening layer which has minimal adhesion during shipping and assembly and which provide substantial adhesion upon application of a significant compression force. The fastening layers 196 are preferably dimensioned to be slightly smaller than the folded half of the photographs 200.

In order to create a photo-album as shown, for example, in FIG. 32 the various components for the album are positioned together on a horizontal surface. A folded end leave 176A is placed on a flat surface, followed by a fastening layer 196A followed be a folded photograph 200A/200B which is then followed by another fastening layer 196B. This is followed by a another folded photograph 200C/200D, by another fastening layer 196C and so on until the final end leave 176B is added. The final assembly is then justified by pressing the assembly against a vertical registration surface while remaining on the horizontal surface so that the folded edges 202A-202E of the photographs are vertically aligned with the folded edge of the end leaves 176A/B and fastening layers 196. The assembly is then rotated 90 degrees and again pressed against the vertical surface to register the assembly alone an edge normal to the folded photograph edges. In that the fastening layers provide no significant adhesion during this process, it is possible to easily reposition the components if needed.

The final assembly is then carefully positioned in a press such as press 78A/78B of FIGS. 8A/8B and then compressed thereby activating the fastening layers 196. It is possible to apply a reduced compressing force so that a proof version can be made. If satisfactory, the proof version can be returned to the press for application of a final compression force. As can be seen in FIG. 32, among other things, the activated layers, such as layer 196B connect the entire back surfaces of adjacent photographs, such as photographs 200A/200B and 200C/200D, together. The photograph folds 202 and end leave folds then are able to function as hinges to flexibly connect the photographs and end leaves together. The bound assembly can then be encased in a conventional hardcover assembly having front and back cover sections 36A and 36B using the pressure sensitive adhesive layers present on the such hardcover assembly. Alternatively, additional fastening layers 196 can be used to secure the bound assembly to a hardcover assembly much like was done in connection with the previously described hardcover of FIG. 30.

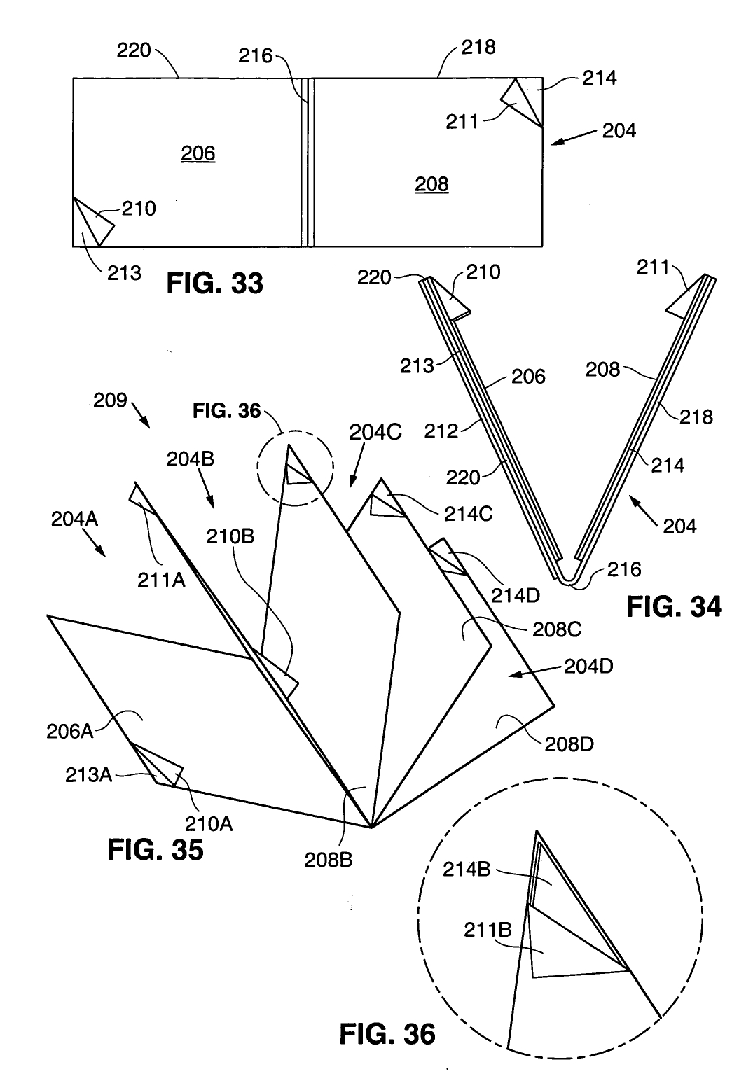

A still further photograph binding approach is disclosed using conventional pressure sensitive adhesives in combination with release liners. This approach does not require the use of the relatively large compression forces needed to activate the fastening layers 196. FIGS. 33 and 34 show a single alternative embodiment carrier sheet arrangement 204. Each arrangement 204 is capable of mounting two photographs or an end leave, with a number of these arrangements being combined to form a carrier assembly 209 shown in FIG. 35. Each carrier sheet arrangement 204 includes a pair of carrier sheets 218 and 220 formed by folding a single sheet around a score or fold line 216. Each carrier sheet 218/220 is capable of mounting a single photograph.

The interior surface of sheet 218 is covered by a layer 214 of pressure sensitive adhesive, with the adhesive layer being covered with a release liner 208. Liner 208 has a folded corner or dog ear 211 which exposes a small portion of adhesive 214. Similarly, the interior surface of sheet 220 is covered by a layer 213 of pressure sensitive adhesive, with the adhesive layer being covered with a release liner 206. Liner 206 also has a folded corner or dog ear 210 which exposes a small portion of adhesive 213. Note that the dog ears 210 and 211 are located diagonally opposite one another so that the exposed adhesives 213 and 214 do not contact one another when the carrier sheet arrangement 204 is folded shut during shipping and the like.

The exterior surface of sheet 220 also has a layer of pressure sensitive adhesive 213. Layer 213 functions to connect the carrier sheet arrangement 204 to an adjacent carrier sheet arrangement, with the interconnected carrier sheet arrangements thus being interconnected to form the carrier assembly 209 of FIG. 35. Carrier assembly 209 is preferably prefabricated with a fixed number of carrier sheet arrangements 204 to accommodate several photographs. When the carrier sheet arrangements 204 are connected together by respective adhesive layers 212 to form assembly 209, the respective fold lines 216 of each carrier sheet are positioned adjacent one another.

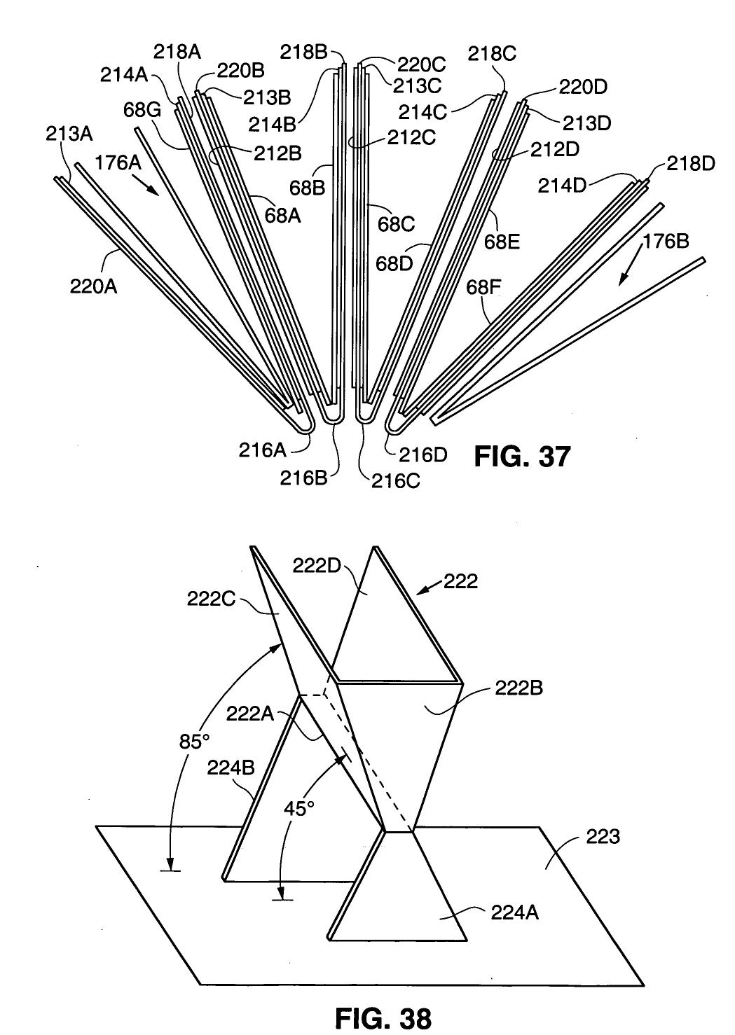

The carrier assembly 209 is further illustrated by FIG. 37 which shows an exemplary carrier assembly, with the release liners removed and loaded with four photographs 68A, 68B, 68C, 68D, 68E, 68F and 68G as will be described. Typically more carrier sheet arrangements 204 are used so that more photographs can be mounted. Although depicted in FIG. 37 in schematic form, adjacent carrier sheets 218A and 220B of differing carrier sheet arrangements are actually connected together by the intermediate adhesive layer 212B. Similarly, adjacent carrier sheets 218B and 220C are connected together by adhesive layer 212C and adjacent carrier sheets 218C and 220D are connected together by intermediate layer 212D. Again, it can be seen that the respective fold lines 216A, 216B, 216C and 216D are disposed adjacent one another.

FIG. 38 is a perspective view of a caddy 222 used to load the FIG. 35 carrier assembly 209 with photographs and end leaves and to align or register the components. Caddy 222 includes a bottom plate 222A, a front plate 222B and two side walls 222C and 222D. Bottom plate 222A and front plate 222B are orthogonal to one another. The caddy 222 is supported in a tilted position on a level surface 223 by members 224A and 224B so that the bottom plate tilts towards a user by about 45 degrees from horizontal. The side walls 222C and 222D are tilted outward by about 85 degrees from horizontal. Thus, when the carrier assembly 209 and photographs 68 are positioned in the caddy 222, they tend to move along the bottom plate 222A by force of gravity so that a bottom and front edges of the components are registered against the respective bottom plate 222A and front plate 222B.

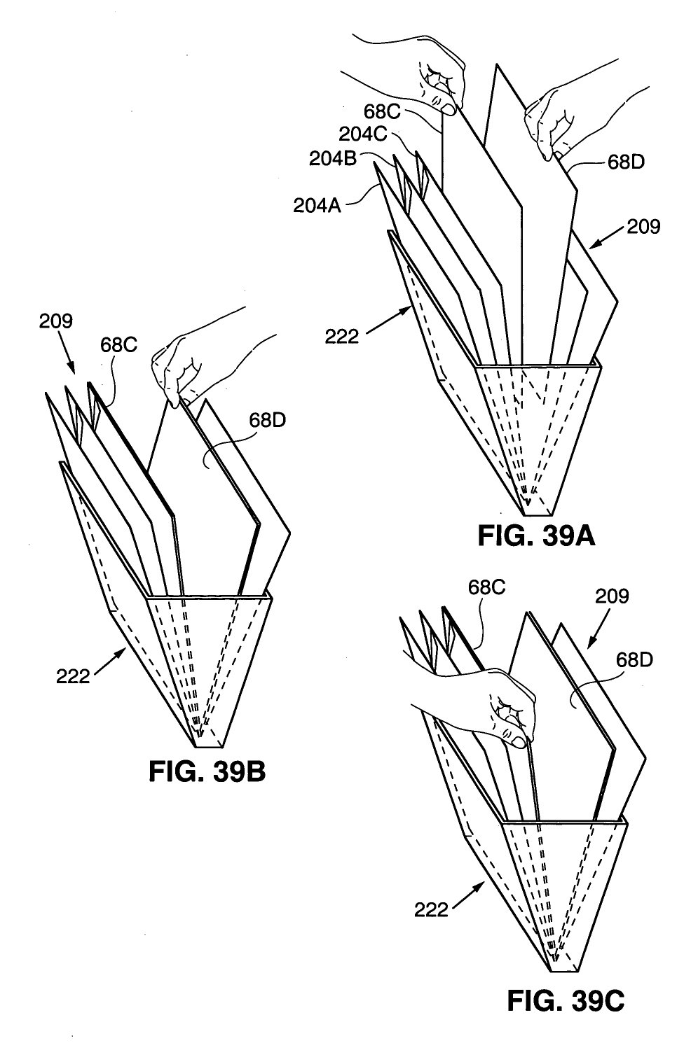

The manner in which a photo-album is created using the carrier assembly 209 will now be described. First, the user positions the prefabricated assembly 209 into caddy 222. Next, as shown in FIG. 39A, the user positions two selected photographs between carrier sheets 218 and 220 of one of the carrier sheet arrangements 204 of the assembly 209. By way of example, photographs 68C and 68D are positioned between the carrier sheets of arrangement 204C, with the image sides facing one another. Care is taken to ensure that the lower edges of the photographs are both resting adjacent fold line 216C (FIG. 37) of the carrier, with the front edges of the carrier sheets and the front edges of the photographs resting against the front plate 222 of the caddy. Note that the slightly outward extension of the dog ears 210C and 211C reduce the likelihood that the photographs will inadvertently contact the exposed pressure sensitive adhesives 213 and 214 adjacent the dog ears during this positioning process.

With the components properly positioned in the caddy 222, the user manually pinches a corner of one of the photographs located opposite one of the dog ears and the surrounding structure together, taking care not to disturb the position of the photograph in the process. For example, in FIG. 39B the user pinches the corner of photograph 68D and the corner of carrier sheet arrangement 204C near dog ear 211C together so that the photograph corner contacts the exposed section of adhesive 214. This action locks in the desired alignment between photograph 68D and carrier sheet 218C of sheet arrangement 204C. Similarly, as shown in FIG. 39C, the user then pinches the corner of photograph 68C and the corner of carrier sheet arrangement 204C near dog ear 210C so that the photograph corner contacts the exposed section of adhesive 213. Again this action locks in the desired alignment between photograph 68C and carrier sheet 220C of sheet arrangement 204C.

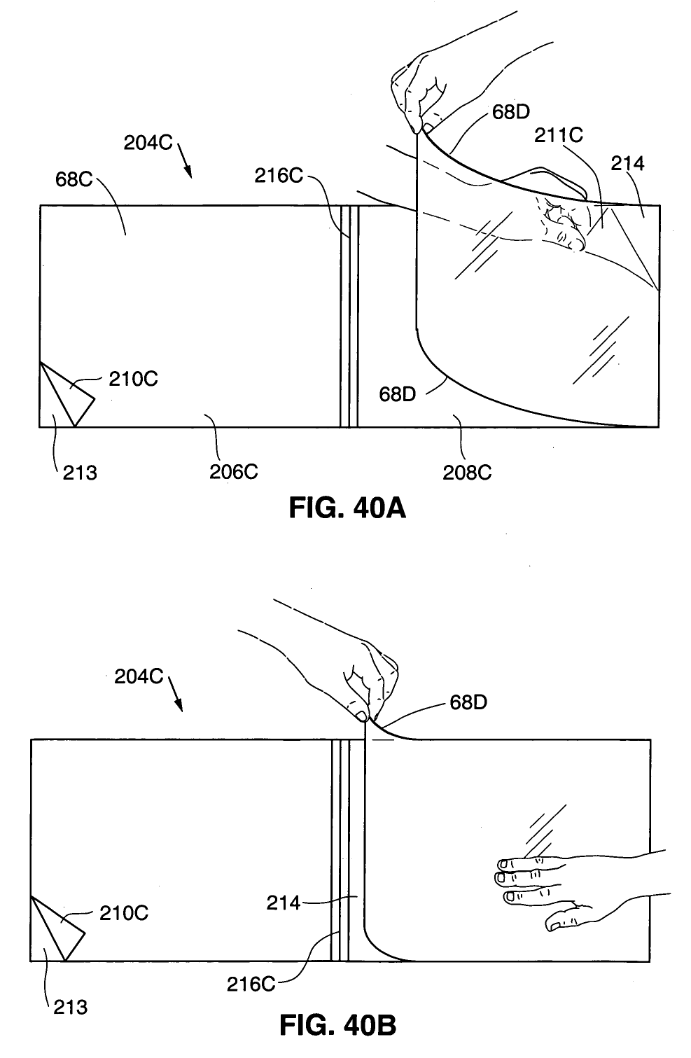

With the two photographs locked into position, the user then lifts the carrier assembly 209 out of the caddy and places the assembly on a flat surface. The assembly is then laid open so that, as shown in FIG. 40A, the two photographs secured at the respective corner, photographs 68C and 68D, are positioned as shown. The photographs of FIGS. 40A and 40B are shown semi-transparent for purposes of illustration. The user then carefully lifts the inner free edge of one of the photographs, such as photograph 68D, to provide access to the underlying dog ear 211C. Photograph 68D remains locked in position by way of the exposed segment of pressure sensitive adhesive 214 during this lifting. Release liner 208C is then peeled away by the user as shown in FIG. 40A. With the release liner removed, the user then presses all of photograph 68D against the exposed adhesive 214, using a rubbing action over the entire surface of the photograph. This sequence is then repeated for photograph 68C, with the free end of the photograph being lifted to provide access to dog ear 210C so that release liner 206C can be peeled away thereby exposing all of the underlying adhesive layer 213. Photograph 68C is then secured using a rubbing action over the entire surface.

The carrier assembly 209 is then closed and returned to caddy 222. Another of the carrier sheet arrangements 204 of the assembly is opened so that an additional pair of photographs can be positioned between the carrier sheets 218 and 220 of the arrangement. The user then repeats the previously described operation of pinching the corners of the photographs and the carrier sheets together to lock the photographs and carrier sheets together at the corners. The assembly is then removed a second time so that the two photographs can then be fully secured as illustrated in FIGS. 40A and 40B.

This sequence is repeated for all the remaining photographs. The front and back end leaves 176A and 176B are each treated as a pair of photographs. End leave 176A (FIG. 37) is installed between carrier sheets 220A and 218A of carrier sheet arrangement 204A in the same manner just described in connection with a pair of photographs 68. The carrier assembly 209 is positioned within caddy 202 and end leave 176A is the positioned between the carrier sheets, the fold of the end leave resting on fold 216A of the end leave. In addition, the forward edges of the end leave and the carrier assembly are positioned resting against front plate 222B of the caddy. The user then pinches the corner of the end leave sheet opposite dog ear, ear 210A for example, together with the corner of carrier sheet 220A, thereby locking the carrier sheet corner and end leave sheet corner together by way of the exposed portion of adhesive 213A. The other sheet of end leave 176A remains free. The carrier assembly 209 in then removed from the caddy 222 so that release liner 208A can be removed as described in connection with FIGS. 40A and 40B and the remainder of the exposed adhesive 214A end leave sheet pressed together. One sheet of end leave 176B is then secured in carrier sheet arrangement 218D in the same manner. The loaded carrier assembly 209 is then installed in a hardcover assembly 36A, 36B and 36C as described, for example, in connection with FIG. 32. The carrier sheet 220A is secured to the inner surface of the front cover section 36A of the hardcover assembly, with the free sheet of rear end leave 176B being secured to the inner surface of the back cover section 36B.

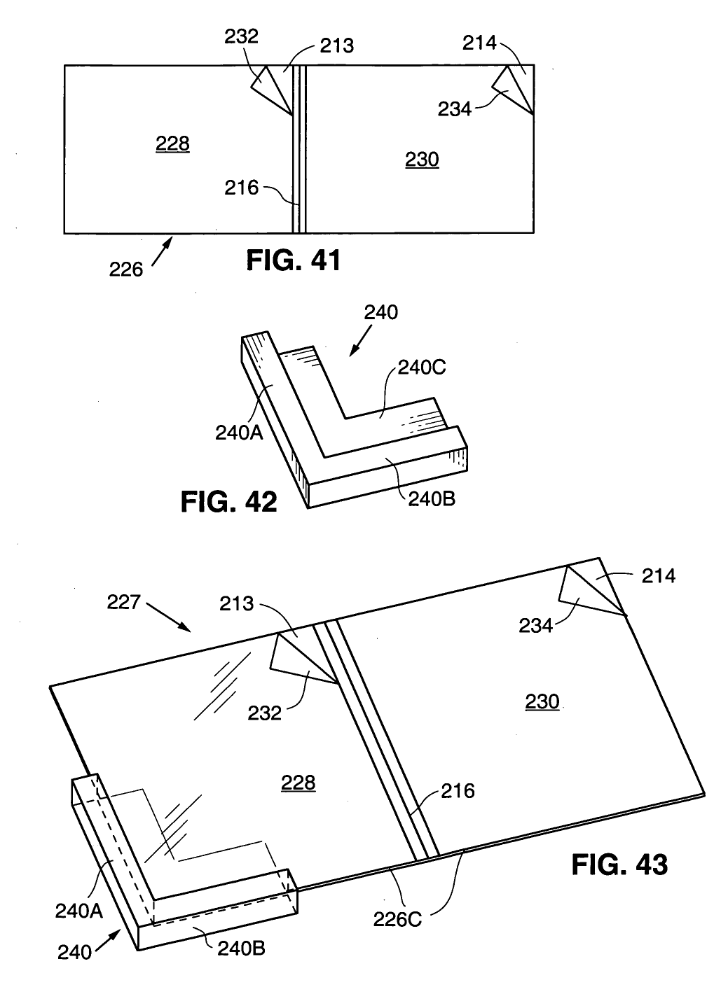

A still further embodiment carrier assembly and method of forming a hardcover photo-album and the like will now be described. A carrier sheet arrangement 226 is shown in FIG. 41, with this arrangement being similar to arrangement 204 of FIG. 33 with the exception of the location of the release liner dog ears 232 and 234. Again, with the dog ears 232 and 234 are located opposite one another as depicted, the exposed adhesive 213 and 214 will not contact one another when the arrangement is moved to a closed position during shipping and assembly. Rather, the exposed adhesive will be facing a section of silicone covered release liner where the adhesion force will be substantially reduced. Again carrier assembly 227 is preferably pre-fabricated by combining two or more of the carrier arrangements 226 in the same manner that carrier assembly 209 (FIG. 35) is pre-fabricated using multiple numbers of carrier sheet arrangements 204 (FIGS. 33 and 34), with the carrier arrangements being secured to one another by an adhesive 212 (FIG. 34). In addition, rather than using caddy 222 (FIG. 38), a registration guide 240 (FIG. 42) can be used as will be described.

Registration guide 240 includes two orthogonal registration members 240A and 240B, each having an inner registration surface for placing against a corner of one of the carrier sheet arrangements 226 that form the carrier assembly and against a photograph 68 so that the photograph and carrier sheet arrangement are accurately aligned. In addition, as will be explained, the registration guide 240 is also used when encasing the loaded carrier assembly 227 in a hardcover assembly. Guide 240 includes a thin base member 240C which permits the guide to be supported when the guide is resting on a flat surface or when the guide is inserted between the carrier sheet arrangements 206 that make up the carrier assembly 227.

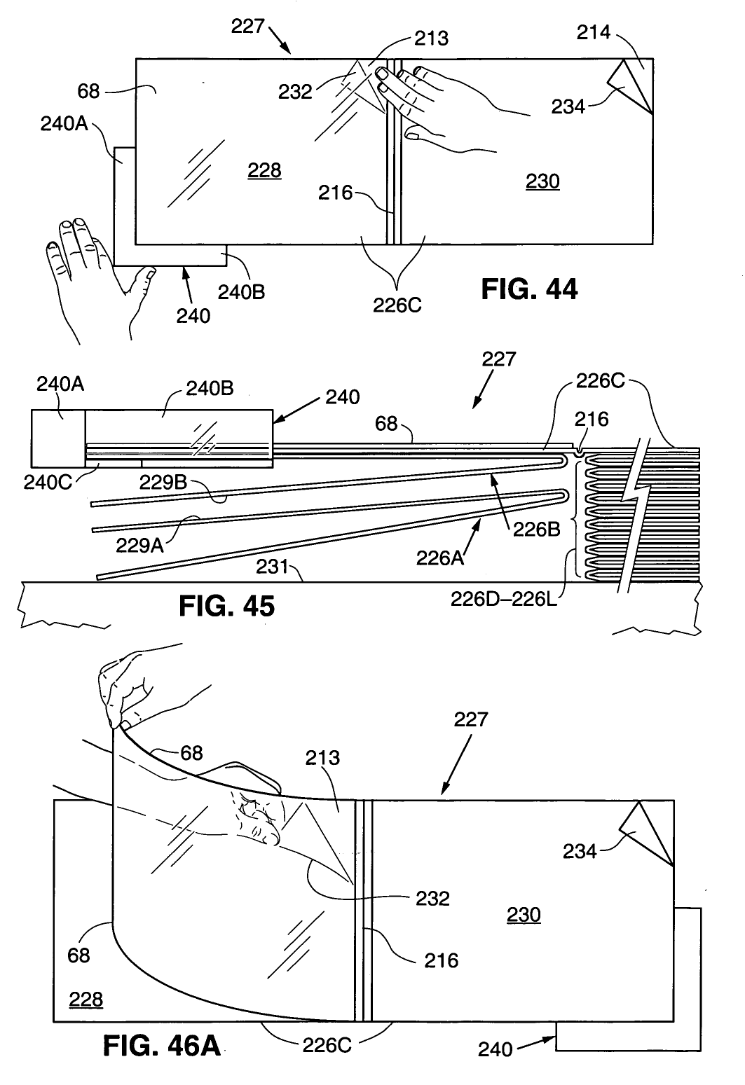

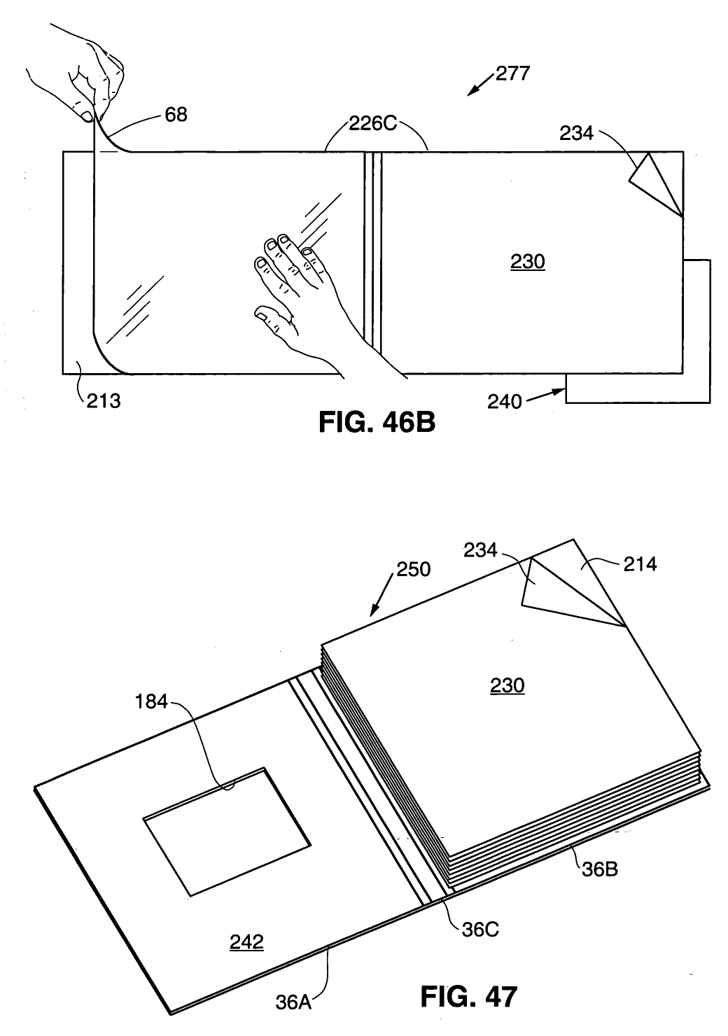

FIGS. 43 and 44 show one position of the registration guide 240 when a photograph 68 is to be installed on one side of a carrier sheet arrangement, the side which includes release liner 228. FIG. 44 shows the exemplary photograph 68 in semi-transparent form for purposes of illustration. Note that the orthogonal edges of the carrier sheet arrangement 226 are contacting the respective inner surfaces of members 240A and 240B. In addition, the orthogonal edges of exemplary photograph 68 is properly positioned as shown in FIG. 44, where the edges also contact the inner orthogonal edges of the guide 240 so that the photograph 68 and carrier sheet arrangement 226 are accurately aligned with one another. When a photograph is to be mounted on the other side of the carrier sheet arrangement, the side which includes release liner 230 for example, the guide is preferably relocated to the position shown in FIG. 46A at a corner other than the corner having the dog ear 234.

FIG. 45 is a schematic side view of the pre-fabricated carrier assembly 227 of FIG. 44 showing that the exemplary assembly is made up of twelve individual interconnected carrier sheet arrangements 226A-226L. The carrier assembly is shown resting on a support surface 231 such as a table top. The figure shows the carrier assembly opened at carrier sheet arrangement 226C so that a photograph 68 can be positioned on one side of carrier sheet arrangement, with the other side of arrangement 226C being located to the right of the fold or score line 216. Folded carrier sheet arrangements 226A and 226B, which had previously been mounted with a photograph and end leave (not depicted), are shown disposed below arrangement 226C.

Although not depicted in FIG. 45 for purposes of clarity, the carrier sheet arrangements 226A-226L are all interconnected by way of an adhesive, such as adhesive 212 of FIG. 34, so the outer surfaces of adjacent arrangements are connected in the same manner as arrangements 204A-204D shown in FIG. 35. Thus, for example, surface 229A of arrangement 226A is secured to surface 229B of arrangement 226B by an adhesive such as adhesive 212 during pre-fabrication. The remaining carrier sheet arrangements 226D-226L are shown folded and await receiving further photographs and finally and end leave. Note that the thin base member 240C of the registration guide 240 allows the guide to be easily positioned between adjacent carrier sheet arrangements as shown in FIG. 45. The carrier sheet arrangements 226A and 226B below guide 240 are shown in FIG. 45 in an expanded form for purposes of illustration but the arrangements will actually be compressed together to form a sold base for the registration guide 240.

With the photograph 68 and underlying carrier sheet arrangement 226C are positioned relative to one another using guide 240, the user then presses the part of the photograph 68 above the exposed adhesive 213 section near the dog ear 232 as shown in FIG. 44. This secures the proper alignment between the photograph and the underlying portion of the carrier sheet arrangement 226C in the same manner as previously described in connection with FIGS. 39B and 39C. Next, as shown in FIG. 46A, the user lifts the free end of the photograph 68 to provide access to the underlying release liner dog ear 232. The user then peels away the release liner 228, with the small section of adhesive 213 maintaining the correct photograph alignment during the process. Once the liner 228 has been removed, the user presses the photograph down against the adhesive layer 213, rubbing the photograph in all regions to ensure a strong uniform bond.

The user then proceeds to secure another photograph to the other half of carrier sheet arrangement 226C in the same manner. The registration guide 240 is repositioned as shown in FIG. 46A adjacent an opposing corner different than the corner near dog ear 234. Note that, as indicated by FIG. 45, the base of the guide will be supported by the underlying folded carrier sheet arrangements 226D-226L which form a solid base. The photograph (not depicted) is then aligned with respect to the other half of the arrangement 226C over release liner 230 using the guide. Once alignment is achieved, the user presses down on the corner of the photograph in the region over the exposed adhesive thereby securing the desired alignment. The user then removes the release liner 230 in the manner previously described and presses down over the entire surface of the photograph thereby finishing the mounting of the photograph. This process is repeated until all of the carrier sheet arrangements are loaded with photographs. In addition, end leaves 176A and 176B are installed using the front and rear carrier sheet arrangements 226A and 226L as was described in connection with FIG. 37. Finally, the loaded carrier assembly 227 is encased in a hardcover assembly 36A, 36B and 36C as described in connection with FIG. 32.

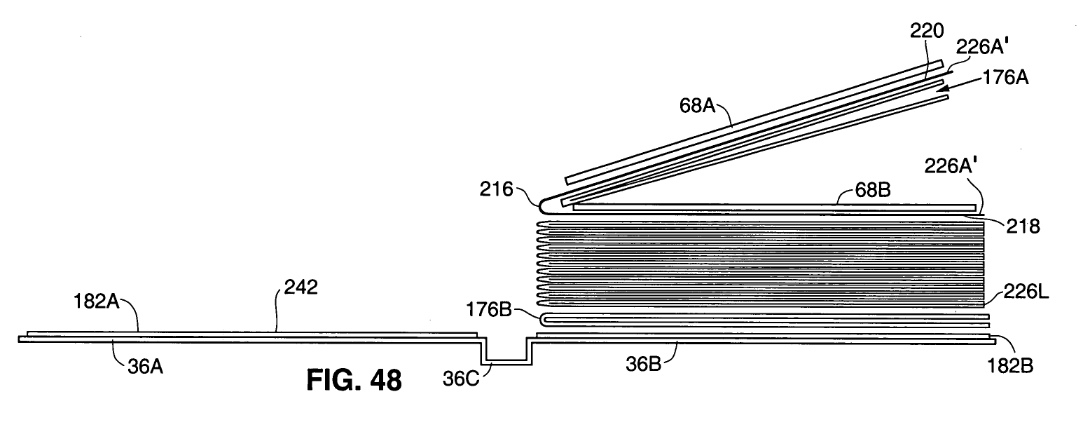

FIGS. 47 and 48 show an encased carrier assembly 250 which is preferably pre-fabricated so that photographs, such as photographs 68A and 68B, can be added by the end user. A center portion of photograph 68A can be viewed through an opening in the front cover section 36A when the album is closes as will be explained. The assembly includes several interconnected carrier sheet arrangements 226 similar to the interconnected arrangements 226A-226L of FIG. 45, for example. As also will be described, the front arrangement 226A′ differs slightly from arrangement 226A previously described and differs also from similar arrangement 204 of FIG. 34. The pre-fabricated assembly 250 includes installed respective front and back end leaves 176A and 176B. As will be described, the carrier sheet arrangements are mounted with photographs in the same manner as previously described in connection with FIGS. 43, 44, 45 and 46A/B.

The front cover section 36A covered by a release liner 242, acts as the support surface 231 of FIG. 45. The hardcover assembly is similar to that of FIG. 22, for example, and includes the previously noted front cover section 36A, a rear cover section 36B and a spine section 36C. The inner surface of the back cover section 36B is pre-attached to one of the end leave sheets of the rear end leave 176B. The other end leave sheet of the rear end leave 176B is attached to the outer surface of the back or last carrier sheet arrangement 226L. Similarly, the front end leave 176A has an end leave sheet which is pre-attached to inner surface of the carrier sheet 220 of the front carrier sheet arrangement 226A′. In that this feature is pre-fabricated, there is no need for a release liner 206 (FIG. 34) on the inner surface of sheet 220. The outer surface of the carrier sheet 220 is also modified from that depicted in FIG. 34 to include a layer of pressure sensitive adhesive 214 as shown in FIG. 47 covered by a release liner 230, with liner 230 having a dog ear 234 so that part of the underlying adhesive 214 is exposed.

The front cover section 36A includes a viewing window 184 similar to the window of the hardcover assembly of FIG. 22. A layer of pressure sensitive adhesive 182A is disposed over the entire inner surface of the hardcover section 36A, with the adhesive layer being covered by a release liner 242. Liner 242 typically has an opening over the hardcover window 184. In that the rear end leave 176B is pre-installed at a manufacturing facility, there is no need for the end user to precisely align the end leave with the carrier assembly formed by the interconnected carrier sheet arrangements 226A or to the rear cover section 36B. For the same reason, the pre-installed front end leave 176A eliminates the need for the end user to align the leave to the remainder of the encased carrier assembly 250.

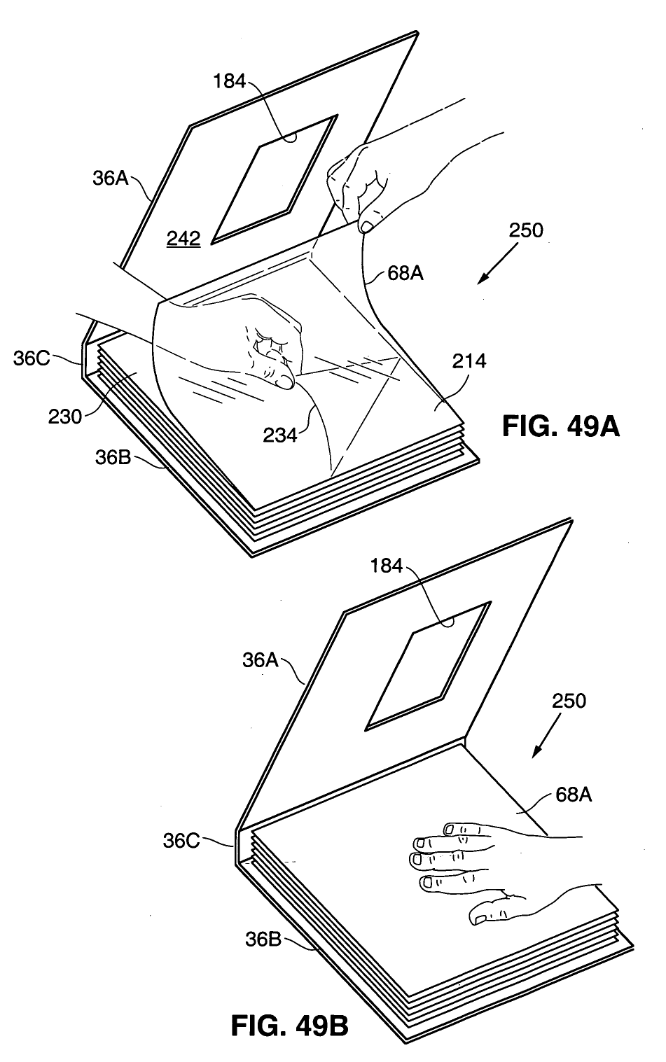

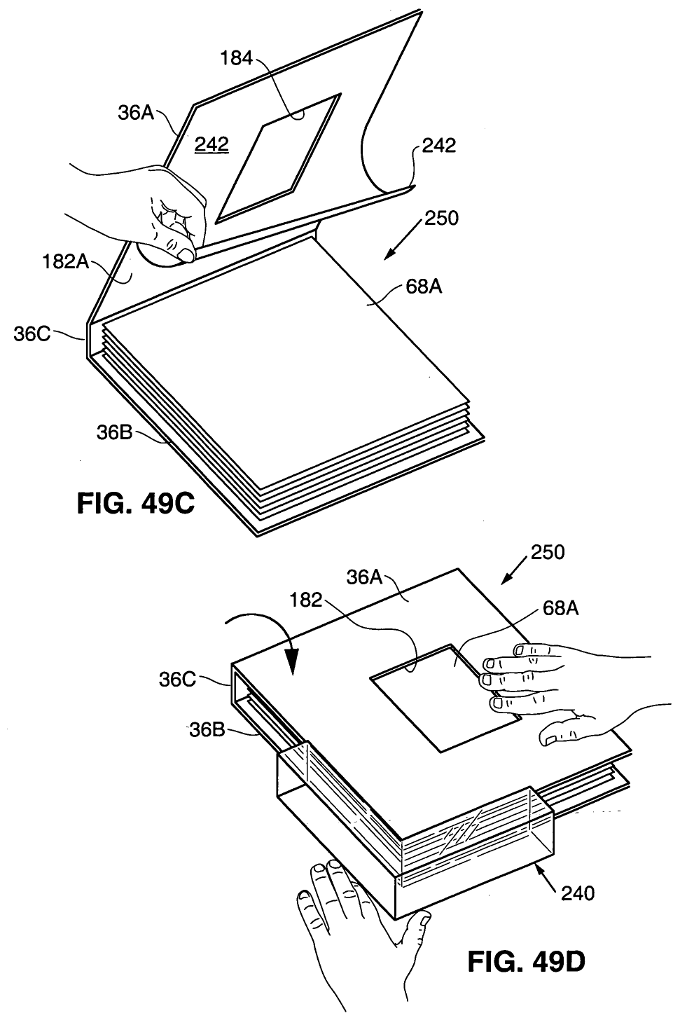

Once the photographs 68B and other photographs 68 are mounted on the carrier sheet arrangements 226A′-226L using the registration guide 240, the photograph 68A to be viewed through the front cover is mounted. Photograph 68A is positioned over the release liner 230, using registration guide 240, with the guide being located on the lower right hand corner since the dog ear 234 is located at the upper right hand corner. The user then presses the upper right hand corner of photograph 68A onto the exposed adhesive 214 adjacent dog ear 234. This locks the photograph 68A into proper alignment with carrier assembly 250 components other than the front cover section 36A. The user then lifts the free edge of photograph 68A (shown a semi-transparent in FIG. 49A) up to provide access to the dog ear 234 and peels the carrier sheet 230 away to reveal the remainder of adhesive layer 214. Next, as shown in FIG. 49B, the user presses down on the entire surface of photograph 68A thereby securing the photograph to the underlying exterior surface of carrier sheet 220 (FIG. 48).

Once the photograph 68A is secured to the carrier sheet 220, the photograph is secured to the inner surface of the front cover section 36A. The user first manually removes all of the release liner 242 as shown in FIG. 49C, and then leaves the front cover section 36A in an open position to that nothing can touch the exposed adhesive 182A. The user them positions the registration guide 240 at one of the rear cover section 36B corners, with the base 240C of the guide resting on a support surface such as a table top. Note that since the rear cover section 36B extends past the photographs and the carrier sheet arrangements upon which the photographs are mounted, only the orthogonal edges of the rear cover section 36B will contact the inner surfaces of the guide. With the guide held in this position, the user then rotates the front cover section 36A over the photograph 68A, taking care not to permit any part of the adhesive 182A to contact the photograph until the corresponding orthogonal edges of the front cover section are aligned with the orthogonal edges of the registration guide. One this alignment of the front cover section 36A has been established, the user then presses the entire surface of the front cover section down on photograph 68A thereby securing the front cover section and the remainder of the carrier assembly 250 in place.

Although various embodiments of the present invention have been described in some detail, it is to be understood that various changes could be made by those skilled in the art without departing from the spirit and scope of the present invention as recited in the appended claims.

1-60. (canceled)

61. A carrier assembly for use in binding a plurality of display sheets, said carrier assembly including:
a first carrier sheet arrangement including first and second carrier sheets and a fold intermediate the first and second carrier sheets, with the first and second carrier sheets each having first and second opposite surfaces, wherein the first and second carrier sheets each have dimensions that generally correspond to dimensions of the display sheets wherein a first layer of pressure sensitive adhesive is disposed over the first surface of the first carrier sheet and a first release liner is disposed over at least a majority of the first layer of pressure sensitive adhesive layer and wherein a second layer of pressure sensitive adhesive is disposed over the first surface of the second carrier sheet and a second release liner is disposed over at least a majority of the second layer of pressure sensitive adhesive layer; and
a second carrier sheet arrangement including third and fourth carrier sheets and a fold intermediate the third and fourth carrier sheets, with the third and fourth carrier sheets each having first and second opposite surfaces, wherein the third and fourth carrier sheets each have dimensions that generally correspond to dimensions of the display sheets wherein a third layer of pressure sensitive adhesive is disposed over the first surface of the third carrier sheet and a third release liner is disposed over at least a majority of the third layer of pressure sensitive adhesive layer and wherein a fourth layer of pressure sensitive adhesive is disposed over the first surface of the fourth carrier sheet and a fourth release liner is disposed over at least a majority of the fourth layer of pressure sensitive adhesive layer and wherein the second surface of the second carrier sheet and the second surface of the third carrier sheet are secured together and wherein the first and second release liners contact one another when the first carrier sheet arrangement is moved to a closed position and wherein the third and fourth release liners contact one another when the second carrier sheet arrangement is moved to a closed position.

62. The carrier assembly of claim 61 further including:
a third carrier sheet arrangement including fifth and sixth carrier sheets and a fold intermediate the fifth and sixth carrier sheets, with the fifth and sixth carrier sheets each having first and second opposite surfaces, wherein the fifth and sixth carrier sheets each have dimensions that generally correspond to dimensions of the display sheets, wherein a fifth layer of pressure sensitive adhesive is disposed over a first surface of the fifth carrier sheet and a fifth release liner is disposed over at least a majority of the fifth layer of pressure sensitive adhesive layer, wherein a sixth layer of pressure sensitive adhesive is disposed over the first surface of the sixth carrier sheet and a sixth release liner is disposed over at least a majority of the sixth layer of pressure sensitive adhesive layer, wherein the second surface of the fourth carrier sheet and the second surface of the fifth carrier sheet are secured together and wherein the fifth and sixth release liners contact one another when the third carrier sheet arrangement is moved to a closed position.

63. The carrier sheet arrangement of claim 61 wherein the first release liner does not extend over a first portion of the first layer of pressure sensitive adhesive, with the first portion being located along an edge of the first layer of pressure sensitive adhesive layer opposite the fold intermediate the first and second carrier sheets, wherein the second release liner does not extend over a second portion of the second layer of pressure sensitive adhesive, with the second portion being located along an edge of the second layer of pressure sensitive adhesive layer opposite the fold intermediate the first and second carrier sheets, wherein the third release liner does not extend over a third portion of the third layer of pressure sensitive adhesive, with the third portion being located along an edge of the third layer of pressure sensitive adhesive layer opposite the fold intermediate the third and fourth carrier sheets and wherein the fourth release liner does not extend over a fourth portion of the fourth layer of pressure sensitive adhesive, with the fourth portion being located along an edge of the fourth layer of pressure sensitive adhesive layer opposite the fold intermediate the third and fourth carrier sheets.

64. The carrier assembly of claim 63 wherein the first and second portions of the respective first and second adhesive layers do not contact one another when the first carrier sheet arrangement is moved to the closed position and wherein the third and fourth portions of the respective third and fourth adhesive layers do not contact one another when the second carrier sheet arrangement is moved to the closed position.

65. The carrier assembly of claim 64 wherein the respective first, second, third and fourth release liners are each folded at a corner to expose the respective first, second, third and fourth portions of adhesive.

66. The carrier assembly of claim 62 further including a hardcover assembly, said hardcover assembly including first and second cover sections connected by a spine section and wherein the second cover section is attached to the first, second and third carrier sheet arrangements and wherein the first cover section is attached to the first, second and third carrier sheet arrangements only by way of the spine section.

67. The carrier assembly of claim 66 wherein the first cover section includes a layer of pressure sensitive adhesive covered by a release liner.

68. The carrier assembly of claim 66 further including a first end leave disposed intermediate the first, second and third carrier sheet arrangements and second cover section.

69. The carrier assembly of claim 68 wherein the first end leave includes a end leave sheet attached to an inner surface of the second cover section.

70. The carrier assembly of claim 69 further including a second end leave which is secured to the first, second and third carrier sheet arrangements, with the first cover section being attached to the second end leave only by way of the spine section.

71. A method of binding a group of display sheets comprising:
providing a carrier assembly which includes first and second interconnected carrier sheet arrangements, with each carrier sheet arrangement including first and second carrier sheets separated by a fold and with the carrier sheets each having dimensions that generally correspond to dimensions of the display sheets and with a surface of the second carrier sheet of the first carrier sheet arrangement being secured to a surface of the first carrier sheet of the second carrier sheet arrangement;
positioning a first display sheet intermediate the first and second carrier sheets of the first carrier sheet arrangement so that the display sheet is aligned with the first carrier sheet;
securing only a portion of the first display sheet to the first carrier sheet using a pressure sensitive adhesive located on the first carrier sheet;
after the securing only a portion of the first display sheet, removing a release liner to expose additional pressure sensitive adhesive on the first carrier sheet and then securing all of the first display sheet using the exposed pressure sensitive adhesive on the first carrier sheet;
positioning a second display sheet intermediate the first and second carrier sheets of the first carrier sheet arrangement so that the display sheet is aligned with the second carrier sheet;
securing only a portion of the second display sheet to the second carrier sheet using a pressure sensitive adhesive located on the second carrier sheet;
after the securing only a portion of the second display sheet, removing a release liner to expose additional pressure sensitive adhesive on the second carrier sheet and then securing all of the second display sheet using the exposed pressure sensitive adhesive on the second carrier sheet;
positioning a third display sheet intermediate the first and second carrier sheets of the second carrier sheet arrangement so that the third display sheet is aligned with the third carrier sheet;
securing only a portion of the third display sheet to the third carrier sheet using a pressure sensitive adhesive located on the third carrier sheet;
after the securing only a portion of the third display sheet, removing a release liner to expose additional pressure sensitive adhesive on the third carrier sheet and then securing all of the third display sheet using the exposed pressure sensitive adhesive on the third carrier sheet.

72. The method of claim 71 wherein the providing a carrier assembly includes positioning the carrier assembly so that the first and second carrier sheets of the first carrier sheet arrangement extend upwards away from the fold and wherein the positioning of the first display sheet includes positioning the first display sheet so that an edge of the first display sheet is resting adjacent the fold of the first carrier sheet arrangement.

73. The method of claim 72 wherein the positioning of the second display sheet includes positioning the second display sheet so that an edge of the second display sheet is resting adjacent the fold of the first carrier sheet arrangement.
